(19) United States
(12) Patent Application Publication
(10) Pub. No.: US 2020/0151815 A1
(43) Pub. Date: May 14, 2020

(54) SYSTEMS AND METHODS FOR A HYBRID SOCIAL TRADING PLATFORM

(71) Applicant: HodlPal, Inc., Cambridge, MA (US)

(72) Inventor: George Calvin Whitfield, Melrose, MA (US)

(21) Appl. No.: 16/456,804

(22) Filed: Jun. 28, 2019

Related U.S. Application Data
(60) Provisional application No. 62/691,457, filed on Jun. 28, 2018.

(51) Int. Cl. G06Q 40/04; G06Q 50/00; G06F 16/901; H04L 12/58

(52) U.S. Cl. CPC G06Q 40/04; H04L 51/32; G06F 16/9024; G06Q 50/01

(57) ABSTRACT

A hybrid trading and social media platform enables users to execute trades in a collaborative manner, benefiting from the collective knowledge of the platform community. To this end, leader-follower relationships are established in a dynamic manner among the platform users and a directed graph is created and maintained in real time to detect inconsistent relationships that may result in unintended or undesired trades. Users can exchange trading ideas and/or actual trades, and comments and feedback on such ideas/trades. One or more followers are provided with performance and/or social metrics of the leader(s) allowing the followers to make informed decisions about the relationships.

### CROSS-REFERENCE TO RELATED APPLICATIONS

This application claims priority to and benefit of U.S. Provisional Patent Application No. 62/691,457 entitled “Systems, Methods and Program Products for a Social Trading Platform for Assets,” filed on Jun. 28, 2018, the entire contents of which are incorporated herein by reference.

### FIELD OF THE INVENTION

This disclosure is generally directed to data structures, processes, and display techniques for electronic trading and, in particular, to a hybrid platform that facilitates both electronic trading and social computer-network-based interactions.

### BACKGROUND

Electronic trading has been around since the '70s and it is generally believed that in the early 2000's Facebook® ushered in the era of computer-network-based social media. In the late 2000's, it is commonly believed, that electronic currencies such as Bitcoin® were introduced as assets for trading on electronic trading platforms. The electronic trading platforms, whether for conventional assets or for assets, and social media platforms typically have different objectives and, as such, different operating philosophies. In an electronic trading platform, the typical goal of the user is to maximize his or her gain. On a social media platform, the typical goal is to maximize social interaction, e.g., by sharing information with others, receiving information from others, and/or discussing and debating topics of interest.

While security and protection of user's personal information and data are generally important to the users of both types of platforms, the actions of the users of a trading platform are typically quite different from the actions of the users of a social platform. Specifically, on a trading platform, a trader generally obtains information from various sources about an asset and, using that information, the user may decide to place a trade order for that asset. The sources of information may be provided by the trading platform or may be external.

The trader may also consider advice and opinions of others, including other traders. The trading platform generally does not provide access to such information, however. The trader may obtain this information from social interactions that take place outside the trading platform. Also, while a trader may receive advice and opinions from others, the trader generally does not have access to any performance data indicating whether the advice/opinion provider(s) acted upon his/her/their own advice and benefited from it.

A user of a social media platform may share, discuss, and/or debate trading ideas with other users of the platform but, the social platform generally does not provide any opportunity to act upon a particular idea, e.g., by placing an actual trade. To do that, the user typically needs to use a different, trading platform. In this scenario also, the user generally does not have access to any performance data indicating whether the advice/opinion provider(s) acted upon his/her/their own advice and benefited from it.

### SUMMARY

While trading is typically considered a competitive activity, trading can be performed in a collaborative manner, to the mutual benefit of several traders. For example, one trader may understand the oil industry well, another may understand the agriculture industry well, and yet another may understand digital currencies well. By sharing proposed trading ideas or actual trades within a community of traders, all traders can benefit from the collective knowledge of the community, when the so called “leaders” lead the trades in their respective areas of expertise and the so called “followers” follow the trading actions of the leaders. A follower with respect to one particular asset (e.g., electronic currency) can be a leader with respect to another type of asset (e.g., rare-earth minerals). Likewise, a leader with respect to one particular asset (e.g., energy stocks) can be a follower with respect to another type of asset (e.g., foreign bonds).

In various embodiments, the systems and methods described herein, facilitate community-based trading for the benefit of the community as a whole. This is achieved, in part, by providing in different embodiments a hybrid trading-social media platform (referred to as a hybrid platform) where a user can place trades through one or more conventional electronic trading platforms, and can also share proposed trading ideas or actual trades with other users of the hybrid platform. With respect to a particular asset, one or more users may be designated leaders and one or more users may be designated followers, who follow the respective leader's action, either automatically or by accepting a proposed action. The hybrid platform provides to each user, including the followers, data about the performance of one or more leaders, so that the users/followers can decide whether following a particular leader would actually be beneficial. Additionally, or in the alternative, the hybrid platform can provide information about the social standing/status of the leaders, e.g., in terms of number of ideas a leader proposes, whether the user response to those ideas is generally positive or negative, etc. A user/follower can taking into account the social standing/status, as well.

The leader-follower relationships can be established on a platform in a dynamic manner. At any time, a user may request to become a follower of another user, making the other user a leader. The user newly designated a leader, however, may be following another user, i.e., another leader. Similarly, at any time, a particular follower may choose not to follow a particular leader or, a particular leader may decide not to allow a particular follower to continue as a follower. Just as a leader can have more than one follower, a follower can have more than one leaders, not only for different asserts, but even the same asset. Moreover, the leader-follower relationship can be asset-specific, as described above, or it can be generic, i.e., applicable to a leader's entire portfolio.

This dynamic and complex nature of the leader-follower relationship can lead to cycles, which can cause a system malfunction. For example, suppose User_A is a leader with respect to a particular asset, User_B is a follower of User_A for that asset, User_C is a general follower of User_B, and User_A is a general follower of User_C. In this case, an action, e.g., a trade in that particular asset, taken by User_A would be replicated on behalf of User_C and, then, the replicated action would be further replicated on behalf of User_A, creating a cycle that may terminate only when the available trading resources of one of the users in the cycle are unintentionally exhausted. To avoid this problem, various embodiments feature a specialized graph structure that can detect any cycles as the leader-follower relationships are created in a dynamic manner.

Accordingly, in one aspect a method is provided for facilitating community-based electronic trading on a hybrid social and trading platform. The method includes the steps of: establishing, for each platform user, one or more links between a platform account and one or more exchange accounts of that platform user. The method also includes, for a first asset, designating one or more platform users as leaders and, for each leader, designating one or more platform users as direct followers of that leader, and generating by a processor, for integrity checking, a directed graph. Generation of the graph includes allocating in memory a node structure for each platform user, and for each leader, providing one or more directed links from the node structure of that leader to respective one or more node structures corresponding to one or more direct followers of that leader. The method also includes testing integrity by the processor by either detecting or confirming absence of a cycle in the directed graph.

In some embodiments, the method further includes performing by the processor the steps of: detecting an action performed by a first leader with respect to the first asset, and recursively traversing the directed graph identifying one or more followers of the first leader, where the one or more followers include at least each direct follower of the first leader. The method may also include generating a respective action copy for each of the identified one or more followers, and selecting a set of eligible followers from the identified one or more followers according to the respective action copy. In addition, the method may include selecting a subset of eligible followers from the set of eligible followers, and executing, for each eligible follower from the subset of eligible followers, the respective action copy by transmitting a respective trading order to a respective exchange using a link between the platform account of that eligible follower and an exchange account of that eligible follower.

In some embodiments, selecting the subset of eligible followers includes selecting each eligible follower from the set of eligible followers that has a respective user property auto-execute. Thus the leader action is executed automatically for the followers that do not wish to see the suggested trade and provide a confirmation in response. The method may further include, for each eligible follower in the subset, displaying, in a display panel of that follower: (i) the respective action copy and (ii) confirmation of a trade based on the respective action copy.

In other embodiments, selecting the subset of eligible followers may include, for each eligible follower from the set of eligible followers that has a respective user property confirm-execute, displaying, in a display panel of that follower: (i) the respective action copy and (ii) a respective user interface (UI) for confirming or rejecting the respective action copy. Selecting the subset may further include receiving from each of one or more eligible followers, via the respective UI, a respective confirmation signal, and including in the subset of eligible followers the one or more eligible followers that provided the respective confirmation signals. Thus, for some followers, the leader action is executed on behalf of a follower only after displaying a copy of the action to that follower and receiving confirmation to execute the order from that follower.

Selecting the subset of eligible followers may include excluding from the set of eligible followers one or more eligible followers for which execution of the respective action copy would occur at a time exceeding a specified time limit or at a price outside of a range associated with a price at which the action performed by the first leader was executed. Thus, if more than specified time has passed after the leader trade and/or the price has changed significantly (e.g., more than a specified value or a specified percentage such as 1%, 2%, 5%, or more) after the leader trade, the copy trade would not be executed for some followers.

In some embodiments, the method further includes, prior to the executing step, ordering by the processor, the subset according to: a time at which a leader-follower relationship was established between the first leader and a particular eligible follower; a degree by which a particular eligible follower is separated from the first leader in the directed graph; a frequency at which a particular follower followed other actions of the leader; a time at which a particular follower last followed another action of the leader; a premium associated with a leader-follower relationship between the first leader and a particular follower; or a randomized order. During the executing step, each eligible follower may be selected in order from the ordered subset.

A trading metric or a social metric may be associated with the first leader. The method may further include displaying in display panels of each one of the one or more followers of the first leader the trading metric or the social metric. The trading metric may include a trading frequency of trades in the first asset by the first trader, an average per-trade profit from trades in the first asset by the first trader, a total profit from trades in the first asset by the first trader; an overall rank of the first trader based on profitability, or a rank of the first trader based on profits from trades in the first asset.

The social metric may include: (i) a number of followers of the first trader with respect to the first asset, (ii) a total number of followers of the first trader, (iii) a number of likes received by the first trader in response to one or more comments posted by the first trader; (iv) a number of dislikes received by the first trader in response to the one or more comments posted by the first trader; or (v) one or more ranks designated to the first trader based on one or more of the social metrics (i) through (iv). In some embodiments, the method may further include displaying in display panels of each one of the one or more followers of the first leader a trading metric or a social metric associated with a second leader with respect to the first asset.

In some embodiments, for each eligible follower from the subset of eligible followers, transmitting the respective trading order includes signing the respective trading order using a respective private key of that eligible follower. The method may also include rewarding the first leader based on a number of eligible follower in the subset of eligible followers. Generating an action copy for each identified follower may include replicating the action of the first leader for a respective follower-trade amount that is a function of: (i) a percentage of a leader-trade amount of the action of the first leader within a portfolio of the first leader, and (ii) a proportion of a portfolio of that identified follower that is designated to follow the portfolio of a direct leader of which the identified follower is a direct follower. Selecting the set of eligible followers from the identified one or more followers according to the respective action copy may include selecting one or more followers from the identified one or more followers having the respective follower-trade amount available for trading.

In some embodiments, for each identified follower, the proportion of the portfolio of that identified follower that is designated to follow the portfolio of a direct leader of which the identified follower is a direct follower is associated with a link between a node in the directed graph corresponding to the direct leader and a node in the directed graph corresponding to that identified follower. Generating an action copy for each identified follower may include replicating the action of the first leader for a respective follower-trade amount that is a function of: (i) a rank of the first leader, (ii) ranks of all leaders the respective follower directly follows, or (iii) ranks of all designated leaders for the asset of interest, where a rank of each leader is based on a trading metric or a social metric for that leader.

In some embodiments, testing integrity includes detecting a cycle in the directed graph, and recursively traversing the directed graph includes: identifying a pair of platform users having a leader-follower relationship that caused the cycle; tagging a follower in the pair; and terminating the recursive traversing when a visit to the tagged follower is repeated. A particular user may be designated as both leader and follower. In some embodiments, testing integrity includes detecting a cycle in the directed graph, and the method may further include identifying a pair of platform users having a leader-follower relationship that caused the cycle; terminating the leader-follower relationship between the platform users of the pair; and displaying an alert message in respective display panels of the platform users of the pair, informing the termination of the relationship.

In another aspect, a hybrid social and trading system comprises a processing unit and a memory unit in electronic communication with the processing unit. The memory unit includes instruction which, when executed by the processing unit, program the processing unit to: establish, for each platform user, one or more links between a platform account and one or more exchange accounts of that platform user and, for a first asset, designate one or more platform users as leaders and, for each leader, designate one or more platform users as direct followers of that leader.

The instructions further program the processing unit to generate for integrity checking a directed graph. To generate the graph, the instructions program the processing unit to allocate in a memory module in communication with the processing unit a node structure for each platform user and, for each leader, provide one or more directed links from the node structure of that leader to respective one or more node structures corresponding to one or more direct followers of that leader. In addition, the instructions program the processing unit to test integrity by either detecting or confirming absence of a cycle in the directed graph. In various embodiments, the instructions can program the processing unit to perform one or more of the method steps described above.

In another aspect, an article of manufacture is provided that includes a non-transitory storage medium having stored therein instructions which, when executed by a processing unit program the processing unit, which is in electronic communication with a memory module, to: establish, for each platform user, one or more links between a platform account and one or more exchange accounts of that platform user and, for a first asset, designate one or more platform users as leaders and, for each leader, designate one or more platform users as direct followers of that leader.

The instructions further program the processing unit to generate for integrity checking a directed graph. To generate the graph, the instructions program the processing unit to allocate in a memory module in communication with the processing unit a node structure for each platform user and, for each leader, provide one or more directed links from the node structure of that leader to respective one or more node structures corresponding to one or more direct followers of that leader. In addition, the instructions program the processing unit to test integrity by either detecting or confirming absence of a cycle in the directed graph. In various embodiments, the instructions can program the processing unit to perform one or more of the method steps described above.

In another aspect, a method is provided for facilitating community-based electronic trading on a hybrid social and trading platform. The method includes the step of: providing a respective first user interface (UI) on respective display panels of one or more platform users, enabling the one or more platform users to initiate a discussion in association with a trade in an asset. The method also includes, upon initiation of the discussion by a first user, displaying on the display panel of the first user a second UI for entering an initial comment, the initial comment comprising a text message, an image, or an emoji, and displaying a respective third UI on respective display panels of a set of platform users, enabling the platform users in the set to post a subsequent comment in response to the initial comment. The subsequent comment may include a text message, an image, or an emoji, or a like or dislike signal. The third UI may include the initial comment. The set of platform users may include platform users associated with the asset or the first user.

In some embodiments, the trade includes a trade executed by the first user or a trade proposed by the first user, and the respective third UI includes a profitability ranking for the asset of the first user or a number of followers of the first user. The method may include, upon posting of a subsequent comment by a second platform user, updating for each platform user in the set of platform users the respective third UI with the subsequent comment. Updating the respective third UI may include displaying therein a profitability ranking for the asset of the second user or displaying a number of followers of the second user. Alternatively or in addition, updating the respective third UI comprises displaying therein a count of subsequent comments, a count of likes, or a count of dislikes.

In another aspect, a hybrid social and trading system comprises a processing unit and a memory unit in electronic communication with the processing unit. The memory unit includes instruction which, when executed by the processing unit, program the processing unit to provide a respective first user interface (UI) to respective display panels of one or more platform users, enabling the one or more platform users to initiate a discussion in association with a trade in an asset. Moreover, the instructions program the processing unit to, upon initiation of the discussion by a first user, provide to the display panel of the first user a second UI for entering an initial comment, the initial comment comprising a text message, an image, or an emoji.

The instructions also program the processing unit to provide a respective third UI to respective display panels of a set of platform users, enabling the platform users in the set to post a subsequent comment in response to the initial comment, the subsequent comment comprising a text message, an image, or an emoji, or a like or dislike signal, the third UI comprising the initial comment. The set of platform users includes platform users associated with the asset or the first user. In various embodiments, the instructions can program the processing unit to perform one or more of the method steps described above.

In another aspect, an article of manufacture is provided that includes a non-transitory storage medium having stored therein instructions which, when executed by a processing unit program the processing unit, which is in electronic communication with a memory module, to: provide a respective first user interface (UI) to respective display panels of one or more platform users, enabling the one or more platform users to initiate a discussion in association with a trade in an asset. Moreover, the instructions program the processing unit to, upon initiation of the discussion by a first user, provide to the display panel of the first user a second UI for entering an initial comment, the initial comment comprising a text message, an image, or an emoji.

The instructions also program the processing unit to provide a respective third UI to respective display panels of a set of platform users, enabling the platform users in the set to post a subsequent comment in response to the initial comment, the subsequent comment comprising a text message, an image, or an emoji, or a like or dislike signal, the third UI comprising the initial comment. The set of platform users includes platform users associated with the asset or the first user. In various embodiments, the instructions can program the processing unit to perform one or more of the method steps described above.

In another aspect, a method is provided for displaying asset prices and order densities. The method includes the steps of: obtaining for an asset at each instance of time in a plurality of time instances during a specified time window, a respective cumulative order volume distribution over a price range; generating for each instance of time in the plurality of time instances a respective order density distribution by computing a price derivative of the respective cumulative order volume distribution; and discretizing each order density distribution over a plurality of price points in the price range.

The method further includes displaying for the asset a price chart on a time-price grid, each grid point corresponding to a respective pair of: (i) an instance of time in the specified time window and (ii) a price point in the price range, and overlaying on the price chart discretized order density values, each discretized order density value corresponding to a respective grid pint, the overlaying step comprising setting an optical property of a pixel at the grid point according to the corresponding discretized order density value. The optical property may include an intensity of the pixel, a saturation of the pixel, or a red-green-blue-alpha (RGBA) value of the pixel. The discretized order density values may include a set of discretized buy order density values and a set of discretized sell order density values, and the overlying step may include setting pixels corresponding to discretized buy order density values to a first color and setting pixels corresponding to discretized sell order density values to a second color different from the first color.

In another aspect, a system for displaying asset prices and order densities comprises a processing unit and a memory unit in electronic communication with the processing unit. The memory unit includes instruction which, when executed by the processing unit, program the processing unit to: obtain for an asset at each instance of time in a plurality of time instances during a specified time window, a respective cumulative order volume distribution over a price range. In addition, the instructions program the processing unit to generate for each instance of time in the plurality of time instances a respective order density distribution by computing a price derivative of the respective cumulative order volume distribution, and discretize each order density distribution over a plurality of price points in the price range.

The instructions further program the processing unit to display or to send a command to display, for the asset, a price chart on a time-price grid, each grid point corresponding to a respective pair of: (i) an instance of time in the specified time window and (ii) a price point in the price range. Furthermore, the instructions program the processing unit to overlay or send a command to overlay on the price chart discretized order density values, where each discretized order density value corresponds to a respective grid point. To perform the overlaying operation, the instructions program the processing unit to set or provide an optical property of a pixel at the grid point according to the corresponding discretized order density value. In various embodiments, the instructions can program the processing unit to perform one or more of the method steps described above.

In another aspect, an article of manufacture is provided that includes a non-transitory storage medium having stored therein instructions which, when executed by a processing unit program the processing unit, which is in electronic communication with a memory module, for displaying asset prices and order densities. To this end, the instructions program the processing unit to: obtain for an asset at each instance of time in a plurality of time instances during a specified time window, a respective cumulative order volume distribution over a price range. In addition, the instructions program the processing unit to generate for each instance of time in the plurality of time instances a respective order density distribution by computing a price derivative of the respective cumulative order volume distribution, and discretize each order density distribution over a plurality of price points in the price range.

The instructions further program the processing unit to display or to send a command to display, for the asset, a price chart on a time-price grid, each grid point corresponding to a respective pair of: (i) an instance of time in the specified time window and (ii) a price point in the price range. Furthermore, the instructions program the processing unit to overlay or send a command to overlay on the price chart discretized order density values, where each discretized order density value corresponds to a respective grid point. To perform the overlaying operation, the instructions program the processing unit to set or provide an optical property of a pixel at the grid point according to the corresponding discretized order density value. In various embodiments, the instructions can program the processing unit to perform one or more of the method steps described above.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. In the following description, various embodiments of the present invention are described with reference to the following drawings, in which: FIG. 1 schematically depicts a centralized hybrid trading and social media platform, according to some embodiments;

FIG. 2 schematically depicts a decentralized hybrid trading and social media platform, according to some embodiments;

FIGS. 3A-31 depict example user interface (UI) panels displayed on a user device, according to some embodiments;

FIGS. 4A-4C depict example UI panels for script-based trading, according to some embodiments;

FIGS. 5A and 5B depict graphs created and maintained by a hybrid platform, according to various embodiments;

FIGS. 6A-6E depict an example series of UI panels used to inform a trading idea to a user, according to one embodiment;

FIGS. 7A-7F depict an example series of UI panels used to inform the user of a rejection of a trading idea by the user, according to one embodiment;

FIGS. 8A-8F depict an example series of UI panels used to inform the user of an acceptance of a trading idea by the user, according to one embodiment;

FIGS. 9A-9E depict an example series of UI panels indicating a transition away from trading idea suggestion mode, according to some embodiments;

FIGS. 10A and 10B depict example order value/volume−price charts for an asset; and FIGS. 11A-11G illustrate overlaying order density on a price chart, where pixel values are selected according to order densities, according to some embodiments.

### DETAILED DESCRIPTION

In various embodiments, the hybrid platform described herein can revolutionize the way people manage their personal assets, including digital assets, e.g., by leveraging crowd-sourced wisdom in making trading decisions. Those sharing their wisdom may be rewarded for their trading skills and contribution to the community. Various embodiments described herein feature:
1. A hybrid social media/asset trading platform that includes
2. A asset index controlled by peer relationships in the hybrid social media/asset trading platform
3. A conditionally scripted sequence of buy/sell operations in the hybrid social media/asset trading platform
4. Automated and semi-automated execution of trades based on peer actions within the hybrid social media/asset trading platform
5. A graphic user interface for review, acceptance, and execution of trades of assets within the hybrid social media/asset trading platform
6. A graphic user interface for the historical display of asset orderbook density overlaid with asset price charts within the hybrid social media/asset trading platform
   The nature of data collected by the hybrid platform is also described.

Some embodiments feature a new type of utility token, and its associated digital economy is discussed. Central to the creation of this token is a new type of consensus algorithm called Proof of Trade, that features distributed computing, and ensures that a user of the hybrid platform trading data is linked to transactions on real digital financial markets. Some embodiments feature token mining, circulation, and redemption within the context of a blockchain.

To leverage crowd-sourced wisdom, an embodiment of the hybrid trading platform may:
1. Track the profit of Every Trade
2. Track the performance of Every Trader
3. Identifies the Best leading Traders
4. Enable a trader to Shadow a leading trader automatically via a specialized, hierarchical, acyclic, queue structure.

In various embodiments, the hybrid platform can offer the following benefits.
From a social aspect, traders can share their performance; follow other, potentially better traders, and discuss the trades.
The hierarchical acyclic queue allows trade automation, and allows one trader to follow another, replicating the other traders' trades.
From a gamification aspect, the leading traders may be ranked, e.g., based on financial performance and/or social performance, and the traders may compete and win prizes.
From a security aspect, personal account balances are private, and any trader can customize what s/he wishes to share. The system data are encrypted and system access requires user authentication.

### A Hybrid Social Media/Asset Trading Platform (Also Called a Hybrid Platform)

In various embodiments, the hybrid platform may provide one or more of the following basic services to its users:
1. Integrate Exchange APIs. Enable a user to control one or more of his/her exchange accounts, through the hybrid platform user interface.
2. Monitor Exchange Account Activity. Monitor a user's activity on the exchange including details of buy/sell orders placed, order history, and fluctuations in market price of assets held.
3. Track Trade Profit. Present a user with a summary of the profit of each trade that a user has made including currently active trades and prior trades in the user's trade history. In this case a trade is defined as the user having entered a financial position with the intent to exit in the future, e.g., buying a asset with intent to sell in the future (this can also apply to futures markets, shorted products, and other derivatives). A “currently active” trade is one where the user entered a position and has not yet exited. Trades in the user's trade history are trades where the user has entered and then exited the position, e.g. by buying a certain quantity of a asset (at an initial price) and then selling the full quantity of the asset (at e.g. a different price). Profit of the trade is calculated as ((price at exit)−(price at entry))/(price at entry).
4. Track Portfolio Profit. Present a user with a time-averaged summary of the user's account profit per unit time, e.g. % profit per period of 24 hours, 7 days, 30 days, 90 days, 1 year, etc. Because an embodiment of the hybrid trading platform monitors the user's exchange account balance and all buying and selling activity performed by a user, it can compute time-averaged profit and present it to the user.
5. Profit Data Sharing. Enable a user, if he/she so desires, to share with other users of an embodiment of the hybrid platform information about the time-averaged profit of the user's account.
6. Trade Data Sharing. Enable a user, if he/she so desires, to share with other users of an embodiment of the hybrid trading platform information about each trade that the user places including: the time at which the user executed each trade, limit or market prices associated with buy/sell orders that are part of the trade, and the relative (percentage) amount of the user's exchange account balance associated with the trade. Importantly, neither the absolute amount of asset purchased nor the absolute amount of currency paid to perform the trade is revealed in this sharing process; only the relative (percentage) amounts are disclosed.
7. Following of Users. Enable a user (in this case, a follower), if he/she so desires, to “follow” one or more other users (leaders) on the hybrid platform and designate a percentage of the follower's account balance that may optionally be used to replicate trades that are placed by the leader. In this context the act of “following” has a number of effects: (a) the leader is notified that the follower has followed him/her, (b) the follower is notified when the leader performs a trade, (c) the follower receives all information that the leader has elected to share regarding the trade, and (d) the follower is provided with the option to execute a new trade using all trade details provided by the leader, where the amount of asset bought/sold by the follower is determined by (i) the percentage of the leader's account balance that is involved in the trade, (ii) the percentage of the follower's account balance that has been designated to replicate trades placed by the leader, and (iii) the follower's absolute account balance (which is known only to the follower and to an embodiment of the hybrid platform) according to the formula (amount of assets purchased by the follower)=(i) x (ii) x (iii).
8. User-Approved Trade Replication. Enable the user (in this case, the follower), if he/she so desires, to review the details of a trade performed by a leader before electing whether or not to execute a new trade based upon the leader's trade.
9. Automatic Trade Replication. Enable a user (in this case, a follower), if he/she so desires, to automatically execute a new trade based upon a leader's trade without reviewing details of the trade performed by the leader.
10. Monetization strategy 1: Subscription. Enable a user (in this case, a leader), if he/she so desires, to charge a periodic (e.g. monthly) subscription fee to any user who wishes to follow the leader's account. This fee may be paid by the follower to the hybrid platform in one embodiment, and in that embodiment the hybrid platform may extract a service fee (percentage) from the follower's payment, and remit the remainder to the leader.
11. Monetization strategy 2: Commission. Enable a user (in this case, a follower) to pay a fee to a leader when the leader performs a successful (profitable) trade and the follower profits from that trade. This fee may be calculated as a percentage of the profit realized by the follower. The fee may be paid to the hybrid platform in one embodiment, and in that embodiment the hybrid platform may extract a service fee (percentage) from the follower's payment and remit the remainder to the leader.
12. Every Trade can be a Discussion. Enable a user to start a discussion thread linked to a specific trade that he/she has created. When the user's followers see the trade, they may also gain access to the discussion thread and have the ability to comment on the thread so that the user may obtain verbal feedback on the trade being placed.
13. Content Like/Dislike. Enable a user to specify his or her opinion about the actions taken by another user of the hybrid platform according to the one embodiment by clicking a button associated with the action and indicative of either positive or negative opinion, e.g. a “Like” or “Dislike” button. Actions that may be liked or disliked may include (but are not limited to) trades performed, trade ideas suggested, individual buy/sell orders within a trade, comments/messages/announcements posted, etc.
14. Review of Like/Dislike Data. Enable a user to view summary and detailed information regarding content that other users have liked and disliked. While browsing content (e.g. trade ideas, discussions) in an embodiment of the hybrid platform, each user may be presented with a summary of the degree to which that content is liked or disliked by the community (e.g. an aggregate like/dislike score or total) as well as the ability to view a list of which users have liked that particular content. In addition, the user may be allowed to review a list of content that has been liked/disliked by him/herself or by another user.
15. Aggregation of Like/Dislike Data. Enable a user to use the aggregate like/dislike score attributed to every piece of content as a quantitative measurement of public sentiment towards that content. The aggregate scores may be displayed in real time (i.e., within a fraction of a second or a few seconds after a like or dislike attribute was added to a piece of content), in the graphic user interface nearby respective content in the platform, so as to inform the decisions that the user may make.
16. Trade Sentiment Feedback to Follower. In the case of a trade idea that is presented to a user of an embodiment of the hybrid platform, enable the user to view public sentiment on the trade idea as a means for the user to evaluate whether that particular trade idea should be accepted and executed within his/her portfolio.
17. Trade Sentiment Feedback to Creator. In the case of a trade idea that is created by a user of an embodiment of the hybrid platform, after the trade has been created and presented to the community for evaluation, enable the user who created the trade to view public sentiment on the proposed trade idea as a means for the user to decide whether to reconsider or modify that particular trade before it is executed.
18. Intra-trade buy/sell Sentiment Feedback. In the case of specific buy/sell operations that exist within a trade that has been created by a user of an embodiment of the hybrid platform, after the trade idea has been evaluated by the community, each specific buy/sell operation may be labeled with a quantitative metric of public sentiment, which may signal to the user (creator) that those particular actions within the trade are either liked or disliked and should be reconsidered or modified (according to popular opinion).
19. Aggregate Social Ranking. Present a user with an aggregate social rank that is computed based upon individual likes/dislikes that other users have expressed towards the content that the user who is being ranked has generated.
20. Aggregate Metrics of User Performance. Present a user with a list of quantitative metrics associated with the performance of a user, such as time-averaged profit, number of trades placed, number of trades in profit or loss, time-averaged size of each trade as a percentage of total portfolio balance. An embodiment of the hybrid platform also enables the user to select the time basis over which these metrics are computed, e.g. 24 hours, 7 days, 30 days, 3 months, 1 year. These performance metric(s) may be updated in real time, e.g., within a fraction of a second or a few seconds after a trade affecting a metric is executed.
21. Plotting of Aggregate User Metrics. For certain quantitative metric(s), present a user with a history of the value(s) of metric(s) over time. For example, an embodiment of the hybrid platform may provide the user with a plot showing time-averaged profit (as a percentage of total portfolio balance e.g. per 24 hour period) as a function of time (e.g. over the range of 30 days). The plot may be updated in real time, i.e., within a fraction of a second or a few seconds after a trade affecting a metric is executed.
22. Plotting of Aggregate Trade Metrics. For each trade that has been initiated, present the user with a plot of the profit associated with that trade (with units of percentage of portfolio balance) as a function of time, based upon e.g. the initial buy price and quantity of asset bought, as well as any intermediate buy and sell order quantities and prices prior to closing the trade position, divided by the total value of the portfolio that created the trade (to convert from an absolute digital currency basis to a portfolio percentage basis). A trade is considered “closed” or “exited” when the entire quantity of asset involved in a transaction for entry to that trade is subjected to a negating transaction, e.g. when all of an asset originally bought is subsequently sold, when an options or futures contract that is purchased subsequently expires, etc.
23. Public Concealment of Portfolio Absolute Value. Protect user privacy by concealing portfolio value (on an absolute currency basis) from other users. Trade and portfolio profit information that is shared among users is converted from an absolute currency basis to a portfolio percentage basis is, so that users of an embodiment of the hybrid platform are not generally aware of the absolute account balances of other users. The concealment of one's account balance from other traders is a generally accepted best practice among traders, to avoid the risk of loss from digital assaults such as hacking, phishing, or other attempts at theft. Conversely, there are many examples of traders on online platforms and conventional social media who share the relative amount of gains realized, i.e. the percentage profit per trade or the percentage profit of an overall portfolio. The metrics that the embodiment of the hybrid platform shares among its users are generally carefully selected to avoid revealing the value of any individual user's portfolio on an absolute currency basis.
24. Private Visibility of Portfolio Absolute Value. Enable each user to view his/her personal portfolio value on an absolute currency basis. Whereas the absolute portfolio value of other users is concealed from each user, his/her own personal portfolio value is generally presented with a clear, immediate, and historical display on an absolute currency basis. The rationale for this is to ensure that the users have fast and easy access to information that is relevant to trading decisions that they may make. A user may want to know the total value of any transaction that s/he may perform.
25. Private Visibility of Portfolio Asset Values. Enable each user to view the value of and total quantity of each asset held within his/her own portfolio on an absolute currency basis. The present value as well as the historical value of the assets held by each user can be tracked and displayed to the same user.
26. Private Visibility of Portfolio Trade Values. Enable each user to view the value and total quantity of each asset involved within each trade executed within his/her own portfolio on an absolute currency basis. The present value as well as the historical value of the trades executed by each user may be tracked and displayed to the user.
27. Visibility of High Performing Users. Present the user with a sorted list of the highest performing users within an embodiment of the hybrid platform according to a selectable range of quantitative metrics such as (for example) time-averaged profit over various periods of time (e.g. 24 hour, 7 day, 30 day, 3 month, 1 year), aggregate social sentiment towards each user, number of trades performed per unit time, number of messages posted per unit time, or number of followers.
28. The Use of Human and Machine Agents as Users. Provide the user with API access to his/her account in an embodiment of the hybrid platform, so that they may access data contained within that embodiment.

### Centralized System

With reference to FIG. 1, some embodiments of the hybrid platform are implemented using a centralized system 100 that generally includes:
1. A Database 102. One or more server computers operating collectively to securely store information for later retrieval by an embodiment of the hybrid platform. The database may also securely store critical information associated with the state of the embodiment of the hybrid platform, including (a) user account login, password, and preferences (b) API keys used by each platform user to access his/her exchange accounts, (c) leader/follower relationships between users, (d) trades performed by each user, (e) comments, likes, and dislikes of each user, (f) the historical aggregate performance of each trade and of each user according to a variety of metrics, (g) historical relative ranking among users within the embodiment of the hybrid platform according to a variety of metrics. The database may be implemented in mySQL or PostgreSQL.
2. A Database Query API 104. An application programming interface (API) to query the database for the purpose of selecting a subset of the total information stored and later using that information in other parts of an embodiment of the hybrid platform, e.g., implementation of a Structured Query Language (SQL) API, which may send SQL language queries to the database, or a non-SQL API.
3. An Exchange API 106. An API to query an Asset Exchange, implementing the ability for a user to place buy/sell orders, cancel pending orders, view order history, view account balances, and query the current market value of assets in the exchange. This may be implemented as a REST API provided by a third-party asset exchange such as Coinbase™, Bittrex™, or Binance™′
4. An Asset Exchange 108. A server that runs computer software that implements an asset exchange, including a asset exchange, facilitating the buying and selling of assets (e.g., stocks, bonds, commodities, mutual funds, options, or assets, such as cryptocurrencies) in a larger market of several user participants, where some of these users are not the users of the hybrid platform. In some embodiments, the asset exchange is not a part of the hybrid platform and may be provided in a web server belonging to or operated by a third-party e.g., as Coinbase™, Bittrex™, or Binance™.
5. The Back-End Server 110. One or more server computers operating collectively to run a computer program product to (a) create, read, update, and/or delete information in the Database via the SQL API, (b) place buy/sell orders, cancel orders, interrogate order and account information, and interrogate market value of assets in a Asset Exchange via an Exchange API, (c) aggregate and analyze user and exchange data, and (d) transmit information to/from other devices using the Back-End Server API. This may be implemented as a Python® based server framework such as Django®, hosted through an Apache® web server.
6. The Back-End Server API 112. An API to securely transmit information between the Back-End Server and the Front-End Server via an intranet or between the Back-End Server and a User Device via the Internet, including query/response messages originating from each and streaming information that is pushed to each without query initiation. At least when communicating over the Internet the Back-End Server API may be encrypted e.g. using TLS 256 bit encryption according to AES, with JWT based authentication of packet contents. This may be embodied as a REST framework (for query/response) or as a websockets framework (for streaming information).
7. The Front-End Server 114. One or more server computers operating collectively to run a computer program that (a) may (optionally) communicate with a Back-End Server using the Back-End Server API (b) stores the client software, and (c) is able to transmit the client software to a user device, optionally combined with information received from the Back-End Server, via the Front-End Server API. This may be implemented as (i) a NodeJS server, (ii) an app store hosting a native mobile (e.g. Android™ or iOS™) or desktop (e.g. Mac™ or Windows™) app. In the case of (ii), the Front-End Server may not communicate with the Back-End Server directly.
8. The Front-End Server API 116. An API to securely transmit information between the Front-End Server and a User Device, specifically to transmit the client software and any accompanying information from the Front-End Server to the User Device for the purpose of running the Client Software on the User Device. When communicating over the Internet the Front-End Server API may be encrypted e.g. using TLS 256 bit encryption according to AES, with JWT based authentication of packet contents. This may be implemented as a hyper text transfer protocol secured (HTTPS) API.
9. Client Software 118. A software that runs on a User Device and (a) displays data collected by an embodiment of the hybrid platform to the User and (b) sends and receives information to/from the Back-End Server via Back-End Server API. This may be implemented as (i) a progressive web application (PWA) programmed in JavaScript, HTML, and CSS, capable of being run in a mobile or desktop web browser or (ii) in a native mobile (e.g. Android™ or iOS™) or desktop (e.g. Mac™ or Windows™) app.
10. A User Device 120. A computer product capable of running the Client Software and making its functionality available to the User. This may include a mobile device, smartphone, tablet PC, or desktop PC, etc.
   In various embodiments, the centralized system may perform one or more of the following operations:
1. Configuring User Accounts. To configure user accounts, (a) the User requests and receives the Client Software on the User Device from the Front-End Server via the Front-End Server API, (b) the User enters configuration information pertaining to an account into a User Device, (c) the User Device communicates with the Back-End Server over the Back-End API, (d) the Back-End Server optionally executes one or more queries to a Asset Exchange over the Exchange API, (e) the Back-End Server optionally executes one or more queries via the SQL API to create, read, update or delete configuration data in the Database pertaining to the User and (optionally) pertaining to other users within an embodiment of the trading platform, (f) the Back-End Server may compute an equation that depends upon value(s) derived via some data aggregation and analysis, (g) the Back-End Server may transmit response data back to the User Device over the Back-End Server API, and (h) the User Device may display the received data to the User as feedback via execution of the Client Software. In some embodiments, configuring a user account includes configuring a user as one who “follows” another user of that embodiment of the hybrid platform. This may be provided by (a) opening a certain website with the embodiment of the platform in a mobile phone web browser, (b) the User logging in to his/her account and requesting to “follow” another user of the embodiment of the platform (i.e. a “leader”) with a certain specified percentage of available asset funds in the user's account, (c) the mobile phone forwarding the “follow” request and associated information to the Back-End Server, (d) the Back-End Server querying the an Asset Exchange account held by the User to confirm the amount of funds that are available for allocation in the “follower” account to replicate trades performed by the “leader”, (e) the Back-End Server performing multiple Database queries to implement the “follow” relationship between the User and the “leader”, (f) the Back-End Server computing an equation that takes as input the percentage of funds to be allocated for replication of trades of the “leader” as specified by the “follower”, the total amount of available funds of the “follower” as confirmed by the Asset Exchange, percentages of “leader” funds involved in active trades as reported by the Database, and providing as output a calculation of total amount of assets (on an absolute currency basis) and relative amount of assets (as a fraction of total portfolio balance) that the “follower” account has allocated to replicate trades of the “leader”, (g) transmitting confirmation of the newly established “follow” relationship and associated asset allocations to the User, and (h) displaying of the received information on the User's mobile phone.
2. Creating Trades. To create a trade, at least two user account configuration operations are necessary: (a) a User must request and receive the latest information on current value of a asset and funds available to purchase the asset, including specification of which asset may be traded, and (b) the User must request and receive confirmation of the creation of a trade, including trade configuration information such as the amount of asset to purchase, the purchase price, any associated subsequent buy/sell operations that may be considered part of the same trade, and any associated comments that the user wishes to attach to that particular trade.
3. Updating Asset Price Information. A background process may run on the Back-End Server to query the Asset Exchange and determine the current market price of each asset that can be traded using an embodiment of the hybrid platform. The current market value of each tradeable Asset may be stored in the Database of the embodiment along with an indication of the time at which that value was recorded.
4. Updating Trade Information. Once a trade has been initiated by a user, the user is generally updated continually via a background process that runs on the Back-End Server. The purpose of this function is to ensure that any subsequent buying or selling operations that may have been configured and queued by the User are executed. To update trade information, (a) the Back-End server runs parallel processes or “threads” that periodically service each active trade, (b) for each active trade, the Back-End Server periodically checks the value of the associated asset as reported by the Database, (c) depending on conditional logic specified by the trade, if the value of the associated asset exceeds/or falls below a certain critical threshold, the trade may be marked as “threshold triggered”.
5. User-Approved Trade Replication. In the case of a trade configured for User Approval, when a trade's threshold is triggered, notification of “threshold triggered” is pushed to the User Device via the Back-End API. At that point the Client Software can present the user with a notification of “threshold triggered.” The user is then provided with the opportunity to act upon the “threshold triggered” information and execute a subsequent account configuration operation (e.g. buy or sell additional assets within the trade). Alternatively, the user may choose to disregard the “threshold triggered” notification. When the user is following a leader, a threshold associated with a trade in a particular asset may be triggered when the leader trades the same asset.
6. Automated Trade Replication. In the case of a trade in a particular asset configured for Automatic Replication, when a trade's threshold is triggered, e.g., when a leader trades the same asset, the Back-End Server may immediately communicate with the associated Asset Exchange via the Exchange API to buy or sell the asset as has been configured in advance by the User. The Back-End Server stores the results of the transaction(s) in the Database via the SQL API. Then, the Back-End Server may transmit notification of actions taken to the User Device Via the Back-End API. The Client Software then displays notification of actions taken to the User.
7. Platform Data Aggregation. While various calculations are being performed by the Back-End Server in response to requests made by Users and by ongoing background processes, additional processes related to analysis and aggregation of platform data can be run. In this manner, on regular intervals and as needed the Back-End Server can interrogate one or more Asset Exchanges; interrogate the Database; and perform internal calculations to compute correlations between data sets; accumulate, integrate and compute time-averaged values of various quantitative metrics; and store historical information regarding aggregate information over time. The stored aggregate information may then be transmitted from the Database to the User Device via the Back-End Server and associated APIs upon User request for review.
8. Alternative Graphic User Interfaces. In some embodiments, the User may interact with the hybrid platform using an alternative customizable graphic user interface (GUI) rather than using the default GUI that is normally provided by the Client Software.
9. Implementing Machine Agents. A User may construct a computer program that programmatically accesses data from an embodiment of the hybrid platform and performs any task that might otherwise be accomplished via a Client Software. To accomplish this, the User may install a computer program that downloads data from the hybrid platform using the Back-End Server API, performs an analysis using the data received from the hybrid platform and optionally from other sources, and send commands, requests, and updates to the hybrid platform again via the Back-End Server API for the purpose of accomplishing certain tasks defined by the User. Such a computer program is called a Machine Agent.
10. Implementing a Trading Engine. A User of an embodiment of a hybrid platform may construct a Machine Agent that takes as input data from the hybrid platform and optionally other sources and controls the trading of assets via the hybrid platform. Such a Machine Agent is called a Trading Engine. That same Trading Engine, if it performs well, can be of value to other users within the embodiment of the hybrid platform who wish to observe and act upon the knowledge of profitable trades. With respect to a trading engine, the User may use the Back-End Server API to download information associated with other users' trading history, the sentiment of users towards these trades executed by the trading engine, profitability of those trades and any other information that would normally be accessible to the User the Client Software on a User Device. The User may then use this data to train the Trading Engine. A user may develop a trading engine in a language and execution environment of the user's choice. The trading engine may be trained according to a selected machine learning technique such as deep reinforcement learning operating via a deep recurrent neural network implemented e.g. in Python using the Google™ TensorFlow™ framework and running on either a laptop, desktop PC, or server computer (e.g. in the cloud) using any desired combination of CPUs, GPUs (graphics processing units), TPUs (tensor processing units), FPGAs (field-programmable gate arrays), ASICs (application-specific integrated circuits), or any form of computational hardware that the User deems appropriate to the construction of a Trading Engine. The User may also provide other input to the Trading Engine in addition to information that is normally provided to a User by the trading, such as information from other news media outlets, other social media websites, financial markets, or exchanges; information from other enterprise applications, servers, or blockhains; information from other third-party data aggregation or artificial intelligence services; or information from additional graphic user interfaces to one or more other human agents (in the latter case for the purpose of constructing a hybrid human-machine intelligence based Trading Engine). The User may use the Back-End Server API to place trades within the hybrid platform as directed by the User's Trading Engine, thus making the performance of that Trading Engine available to other users of the platform, either for free or as a premium service depending on the User's preference and the specified account configuration.
11. Implementing a Social Engine. A User of an embodiment of a hybrid platform may construct a Machine Agent that takes as input data from the platform and optionally from other sources, and controls other interactions with the platform other than the execution of trades. Such a Machine Agent is called a Social Engine. The Social Engine can operate similarly as a Trading Engine but may issue a different set of commands via the Back-End Server API that are not necessarily involved with the placement of trades. Such alternative commands may generally include a broad range of social interaction functionality. For example, a Social Engine may monitor social and trading data of one or more users of the platform and then send a message to a discussion thread linked to a trade or a user in public or in private for the purpose of informing that discussion thread of the result of some analysis performed by the Social Engine. As an example, a Social Engine may monitor social and trading data of one or more users, attempt to identify a pattern in trades performed by those users, and then send those users suggestions on new trades to perform that meet the pattern of trades that were previously executed. A Social Engine may evaluate one or more users actions according to certain metrics and send a message to the users with advice on how to alter their trading strategy. A Social Engine may monitor data sources external to the hybrid platform such as news media outlets, other social media websites, financial markets, or exchanges and send a message to inform one or more users of the platform of a conclusion drawn from the externally accessed data that is relevant to a trade or discussion within the hybrid platform. A Social Engine may monitor information available from a variety of sources and may warn one or more users of the platform of various factors that may expose their working capital to elevated levels of risk, such as fluctuations in market liquidity, volume, or volatility. A Social Engine may inform users of the hybrid platform of arbitrage opportunities. A Social Engine may inform the platform users of an opportune time to purchase a asset. A Social Engine may implement any asset indicator product that is generally known to the public or developed in private, such as moving averages, oscillators, correlation coefficients, directional movement indicators, relative strength index, price volume trend, money flow index, Bollinger bands, or any other indicator and inform users of the platform of the present value of this indicator. The output of the Social Engine may be received and viewed by a user of the platform as a message posted in a discussion thread attached to a trade by one or more users. Alternatively, an Alternative Graphic User Interface may be constructed that post-processes the output of the Social Engine and displays it in a more concise format, for example showing the output of an indicator algorithm as a number attached to a trade, which is periodically updated. Both the Client Software and the Back-End API may support the concise and efficient transmission and display of information conveyed by new Social Engines that the platform users may develop.
12. Employing a Machine Agent. One way for a User to make use of a Machine Agent in an embodiment of the hybrid platform is to follow the Machine Agent as the User would follow any other user of the platform. This gives the User access to any trades that the Machine Agent performs and any messages that the Machine Agent posts. In addition a user may wish to have private access to a particular Machine Agent, in which case an a Machine Agent that is configured for such interaction may be send private messages to the User. To configure a Machine Agent that is capable of being configured by a User within the hybrid platform, the User may send the Machine Agent a public or private message according to a specified set of commands supported by the Machine Agent and any associated configuration data that is needed.
13. A Hybrid-Platform User Account Public-Private Keypair. A pair of cryptographic keys may be used to identify (in the case of the public key) and control (in case of the private key) a User account in one embodiment of a hybrid platform. The Account Public-Private Keypair may be related by an equation that allows the Public Key to be generated using the Private Key as input to the equation. The Private Key, however, may not be reconstructable from the Public Key.
14. Digitally Signing Data. A User of an embodiment of a hybrid platform may use his/her private key to digitally sign data provided to the platform for the purpose of confirming that the data was generated by the User and is linked to a particular user account within the platform, which can be identified from the associated Public Key.
15. A Hardware Authentication Device. A device that is capable of generating a Hybrid-Platform User Account Public-Private Keypair, transmitting the Public Key out of the device for external reference, securely storing the private key internally to the device without exposing it to any external access, receiving platform Data to be digitally signed, digitally signing the data without disclosing the Private Key, and reporting the digitally signed data externally to the Device without disclosing the Private Key. Examples of hardware authentication devices include but are not limited to Ledger Nano S™, Trezor™, or any other device that is running appropriate firmware that is capable of interfacing with an embodiment of the hybrid platform.
16. Integrating Hardware Authentication Devices. The Client Software may incorporate the use of a Hardware Authentication Device for the purpose of digitally signing platform data in a secure environment and hence thus linking Data that is generated by a User to a specific hardware device. This can provide additional security to a User who desires to prevent others from gaining unauthorized access to the User account. The User may also create or customize an Alternative Graphic User Interface that integrates the use of a Hardware Authentication Device of his/her choice.

### Distributed System

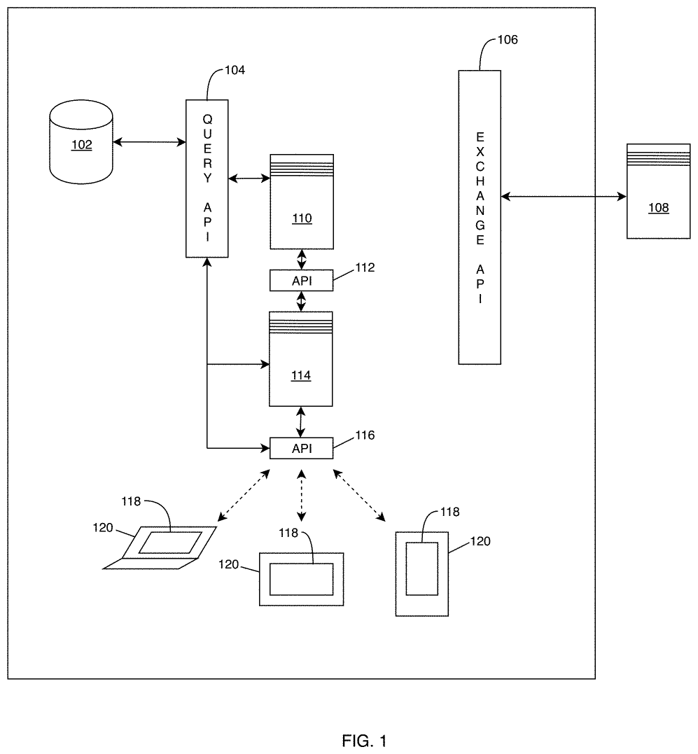

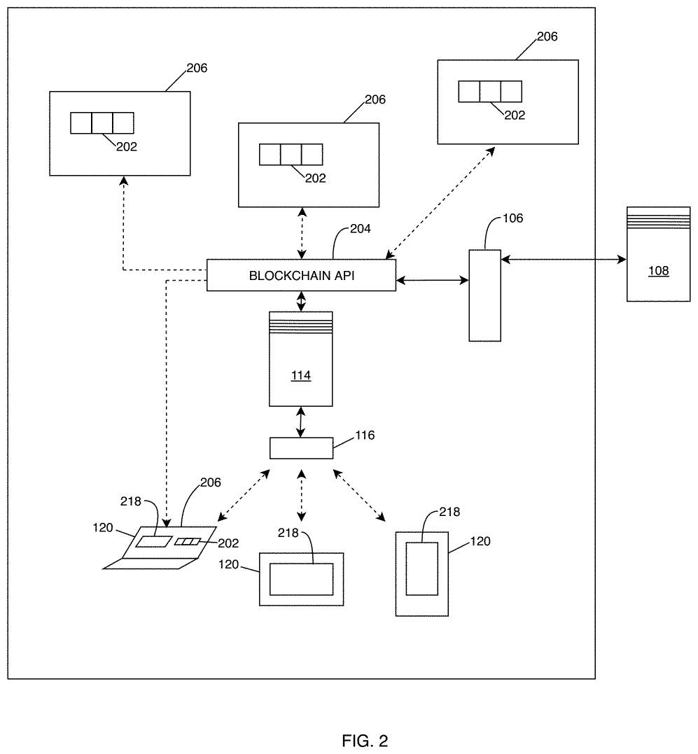

With reference to FIG. 2, Some embodiments of a hybrid platform are implemented using a Distributed System 200. In various embodiments, the distributed system is generally similar to the embodiments of Centralized System 100. Some differences include, however, the use of a Blockchain (instead of Database), and a Blockchain API (instead of a database query API). The Client Software, and all associated APIs are modified for use with a blockchain. In particular, various embodiments of a distributed system may include:
1. A Blockchain 202 (instead of a Database). Instead of using a Database, the entire state of an embodiment of the hybrid platform is stored in a distributed ledger (blockchain) running on several computational machines that are in communication one another so as to confirm validity of any proposed update to the ledger, e.g. implemented as a blockchain, a tangle, or some other form of directed acyclic graph. The blockchain may additionally provide certain functionality previously implemented by the Back-End Server, enabling analysis of platform data and the execution of tasks performed by the back-end server. By nature of running in the blockchain, these tasks formerly relegated to the Back-End Server are executed and verified by multiple machines in parallel.
2. Blockchain API 204 (instead of a database query API). An application programming interface (API) to query the distributed ledger (blockchain) for the purpose of selecting a subset of the total information stored and later using that information in other parts of the platform, i.e. implementation of a Blockchain Query API that may provide functionality analogous to SQL. Examples of blockchain technology replicating in part SQL style queries include Hyperledger™, Catena™, Presto™, BigchainDB™, and other distributed applications built upon existing blockchains such as Ethereum™, Neo™, and RChain™, to name a few.
3. An Exchange API 106. Same as in the centralized system.
4. An Asset Exchange 108. Same as in the centralized system.
5. The Decentralized Application i.e. DAPP 206 (instead of Back-End Server). In the case of a Distributed/Blockchain System, all functionality previously contained in the centralized back-end server is implemented via a combination of functions performed by the Client Software working in concert with a decentralized application (DAPP) that runs on one or more computing nodes that implement the hardware infrastructure of the Blockchain. Any automated or background processes that were run by the Back-End Server may be run by the DAPP, so that they may continue when a User closes a Client Software. The Client Software Product can implement user event driven communications with the Asset Exchange and with the Distributed Ledger.
6. The Back-End Server API. Not used in the distributed system.
7. The Front-End Server 114. Same as in the centralized system.
8. The Front-End Server API 116. Same as in the centralized system.
9. Client Software 218. Same as in the centralized system, except, as noted above the Client Software includes additional functionality substituting for the Back-End Server. The Client Software may, double as a computational node running the DAPP, supporting the Blockchain, and thus supporting the execution of background tasks of an embodiment of the hybrid platform.
10. The User Device. Same as in the centralized system.
11. Through 26. Configuration, Monitoring, Trading, and Analysis, Creating and Employing Machine Agents, Digitally Signing Data and Making Use of Hardware Signing Devices. Same as in the centralized system, with the added requirement that these actions are executed and confirmed over several machines in the blockchain. To ensure that these actions meet user requirements in terms of speed of execution, the blockchain may support sidechains or some form of sharding, to enable a rapid and responsive user experience. The side chains or shards may be organized in a way that promotes rapid communication among existing networks within an embodiment of a hybrid platform, e.g. users who are strongly related via follower relationships in the platform may be grouped together in a sidechain so that they all receive rapid notice of occurrence of a “triggered trade” and have the opportunity to react as quickly as possible, either with user interaction (approval of a replicated trade) or without it (automatic execution of a replicated trade).
   Comparison of Centralized vs. Distributed Systems
   Advantages of the Centralized Platform generally include:
   Faster development time than a distributed system
   Relatively simpler implementation of the Proof of Trade consensus algorithm
   Server architecture, data structures and/or code may be controlled by a single entity.
   Purpose-built, dedicated servers that support high volumes of exchange transactions may be used.
      Advantages of the Distributed Platform include:
   User data is stored in the blockchain, which is robust against hacking
   Exchange transactions originate from user computers and masternodes, scaling naturally to support demand
   User data is encrypted in the distributed ledger and can be audited for verification
   API keys are stored locally on user machines (or on HW wallets, e.g. U2F™)

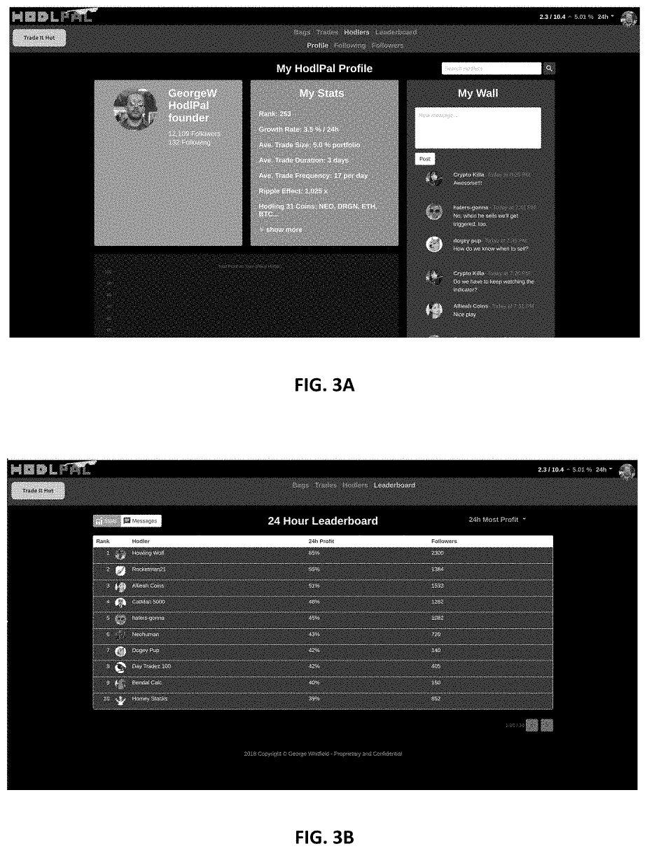

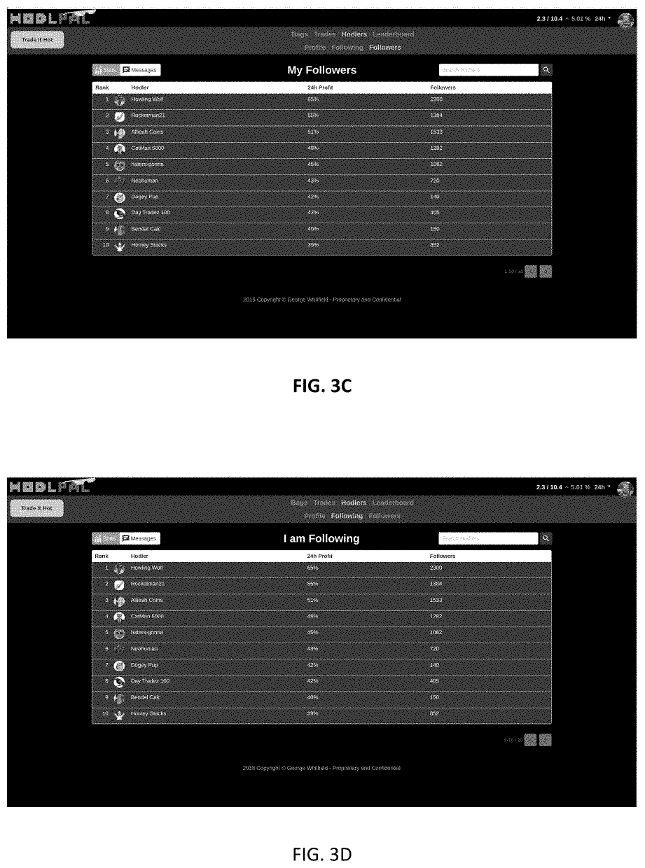

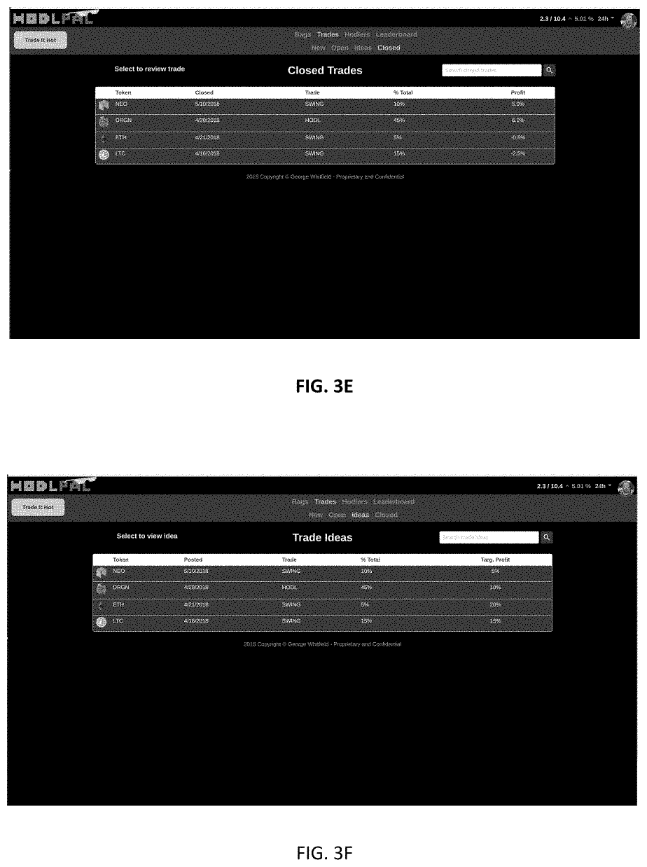

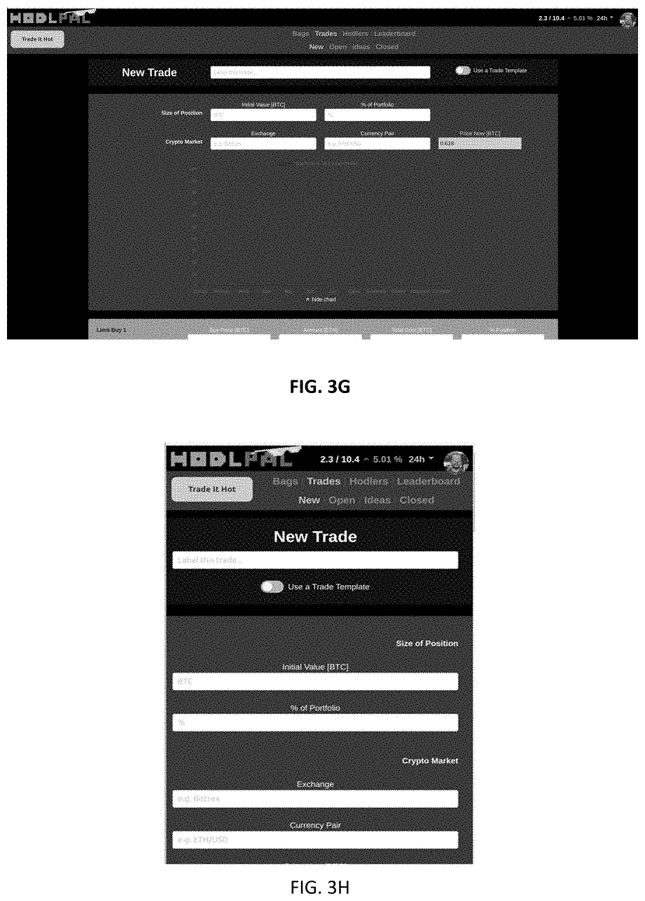

With reference to FIG. 3A, a user interface (UI) 300 in one embodiment of the Client Software displays user profile information. A panel 302 displays the name and, optionally, a picture of a particular user, the number of followers of that user, and a number of other users that particular user is following. A panel 304 shows trade statistics for that user, and panel 306 presents a “wall” where messages from other users may be posted and where that particular user may respond to such messages.

FIG. 3B shows a leaderboard panel 310, e.g., the most active leaders, the most profitable leaders, etc., during a 24-hr time period. The time period may be changed, e.g., to one week, one month, one hour, etc. The leaders displayed may include all leaders on the hybrid platform, or the leaders associated with a particular asset. FIG. 3C displays a panel 320 that shows the followers of the particular user, and their trading performance, e.g. profit in the past 24 hrs., number of trades in the past 24 hrs., etc. FIG. 3D shows a panel 330 that is similar to the panel 310, except for only those leaders that the particular user is following are included in the panel 330.

Panels 340 and 350, in FIGS. 3E and 3F display, respectively, closed trades and proposed trade ides that other users of the hybrid platform may have proposed and that the particular user may consider. The proposed trade ideas panel 350 includes a user interface (e.g., a button) 350 labelled “Trade it Hot,” which is discussed below. FIG. 3G shows a panel 360 using which the particular user can enter a new trade.

In various embodiments, the software client is built as a progressive web application, where the graphic user interface adapts to the size of the user device screen. To illustrate, FIGS. 3A-3G show panels that may be displayed on a relatively larger screen, such as on a laptop or a tablet. FIGS. 3H and 31 show panels 370 and 380 that are similar, respectively, to the panel 360 shown in FIG. 3G and panel 310 shown in FIG. 3B, where the panels 370 and 380 are customized for display on a relatively smaller screen, such as the screen of a smart phone.

### Creating a Asset Index Controlled by Peer Relationships in a Hybrid Social Media/Asset Trading Platform

In various embodiments, a hybrid platform enables users to construct asset indices based upon peer relationships that they have established within the hybrid platform. This allows for commoditizing the trading related activity of any user account within the hybrid platform, whether controlled by a human or a machine agent, and using that activity to generate an automatically balanced portfolio of assets, including digital assets.

Specifically, in one embodiment:
1. A User creates an account on the hybrid platform.
2. As may be necessary, the User provides the platform with information necessary to control one or more Asset Exchange accounts. This is generally accomplished by uploading API keys associated with the exchange accounts to the platform and identifying the exchange with which each is associated.
3. Embodiments of the hybrid platform provide the user with the capability to buy and sell assets in Exchange Accounts that are held under the control of the User. These Exchange Accounts may be provided via=one or more third-party services such as Coinbase™, Bittrex™, Binance™ to name a few asset exchanges. The services are accessed via commands that are issued from a Server that is part of the hybrid platform or a User Device using the User's API Key. While these commands may be manually triggered by the User from within the Client Software, for the purpose of implementing a Asset Index Controlled by Peer Relationships the actions may be automatically triggered.
4. A User may identify other users of the hybrid platform that trade in a manner that the User wishes to replicate, and the user can Follow such other users. When following another user, the User, also called a follower, may designate a specific percentage, hereinafter called the Follower Initial Percentage, of the User's portfolio that may replicate trading actions of the user who is being followed, hereinafter called the Leader.
5. When the User follows the Leader, the hybrid platform updates the Database (or Blockchain) with configuration data that allows the Back-End Server (or DAPP) to automatically control certain trading activity within the User's portfolio when the Leader's trading portfolio is also subject to such trading activity.
6. If the Leader creates a new trade by buying a certain asset in a certain Asset Exchange and consumes a certain percentage (the Leader Initial Percentage) of the Leader's total portfolio balance, then the hybrid platform creates a similar trade for the follower User's portfolio by buying the same asset in the same Asset Exchange, consuming a percentage of the User's portfolio (the User Initial Percentage) given by:

(User Initial Percentage)=(Leader Initial Percentage)*(Follower Initial Percentage)
7. The Leader may physically initiate the buy or sell or any other process by pressing a button in Client Software running on the Leader's User Device. That User Device would then transmit a buy (or a corresponding) command to the Back-End Server via the Back-End Server API or to the DAPP, and the Back-End Server (DAPP) would query the Database (or Blockchain) using the SQL API (or Blockchain API) to retrieve the Leader's API Key and the API Keys of the follower User and other users who are following the Leader. In addition the Back-End Server may query from the Database (or Blockchain) all information necessary to determine that the Leader and the Leader's followers are capable of buying (or selling) the asset (or making another transaction in that asset) in the specified exchange (e.g. confirming that each follower has access to the same Asset Exchange, confirming that each follower has an available portfolio balance that is suitable to replicate the Leader's buy action, etc.). Then, the Back-End server may execute the buy (or sell or another) operation of the Leader and of each preliminarily qualified follower.

The order in which follower buy (or sell or other) operations are executed after the Leader may be determined by one of multiple approaches. In one scenario, the Follower orders may be executed in the which Followers originally followed the Leader, giving preference to the followers who have been following the Leader for a longer period of time. In another scenario, Followers may be offered to pay in advance a premium subscription fee that is a function of the Follower's place in line when orders are executed, effectively creating a bidding market to encourage Followers to pay more for the right to have their orders executed first. In another potential scenario, the order of execution of Follower trades may be randomized, which has the benefit that over time and large numbers of trades all Followers are treated generally equally.

The order in which trades are executed may matter in cases of rapid price movement, where the time required to place the Followers' orders at the Asset Exchange can be significant as compared to movement of price of the asset to be bought or sold. The impact of Follower ordering on attainable follower price becomes more pronounced as the number of Followers attached to a single leader increases. Similar effects are felt for followers of followers and so on.

To compensate for rapid price movements in a asset, buy/sell ranges or “fuzzy” price targets may be used to ensure that only the desired buy or sell operations are executed for leader and followers during price movement. In this case, instead of specifying only a limit buy or sell target value, the Leader may specify a limit buy or sell target range, permitting followers to continue to execute buy and sell operations triggered by the leader so long as the price remains within the specified range.

Once the orders have been sent to the Asset Exchange from the Back-End Server (or DAPP), one or more processes may be started by the Back-End Server/DAPP to monitor each order in the Asset Exchange and to confirm if and when the respective orders successfully run to completion. The Back-End Server/DAPP may poll the Asset Exchange at a predetermined rate (e.g. once every second or once every 10 seconds) to determine when the buy or sell operation has completed. This polling query may be optimized to update the status of multiple pending orders for each user if they exist. In addition the polling process may be optimized by polling the price of the underlying asset at a relatively high frequency (e.g. once every second or once every 0.1 seconds), detecting when the price has crossed the threshold where the pending order is expected to be filled, and confirming that it has been filled by contacting the Asset Exchange. The rate at which the hybrid platform may poll the Asset Exchange to confirm an order may be calculated as a function of proximity of the current asset price to the specified order limit price and the volatility of the asset, with polling rate increasing as proximity decreases and volatility increases.

The status of the order would be updated in the Database (Blockchain) by the Back-End Server (DAPP) as updates are received from the Asset Exchange. At any point in time the Leader or any User may query the Back-End Server (DAPP) to determine the current status of an order that was initiated and may be pending as a component of a Trade that is being performed by the User.
8. The value of a asset may generally vary from its initial value after it is bought, by a multiplicative factor (Trade Rel Value). Hence after a trade is performed by the Leader, it can have a measurable impact on the Leader's portfolio value. With the assumption that all other trades performed by the Leader have constant value(s) (and given that Leader Percentage is expressed such that 100% represents a value of 1), the impact of this particular trade on the Leader's portfolio value (Leader Portfolio Rel Value) may be expressed as:

(Leader Portfolio Rel Value)=(((Trade Rel Value)−1)*(Leader Initial Percentage)+1)

The new value of the trade in the Leader portfolio (Leader New Percentage) is given as:

(Leader New Percentage)=(Trade Rel Value)*(Leader Percentage)/(Leader Portfolio Rel Value)
9. As the value of a trade performed by a Leader varies, the value of the corresponding trade often causes a change in portfolio value of a following User, which can be expressed as:

(User Portfolio Rel Value)=(((Trade Rel Value)−1)*((Leader Initial Percentage)*(Follower Initial Percentage))+1)

The new value of the trade in the User portfolio (User New Percentage) is given by:

(User New Percentage)=(Trade Rel Value)*(Leader Initial Percentage)*(Follower Initial Percentage)/(Leader Portfolio Rel Value)
10. Due to variation of the value of the trade, the percentage of the User's portfolio that is currently following the Leader's (Follower New Percentage) portfolio may generally vary from the percentage that is initially specified when the User first Follows the leader, as described by:

(Follower New Percentage)=(User New Percentage)/(Leader New Percentage)
11. If the Leader updates an open trade by buying or selling a certain quantity of a asset in a certain Asset Exchange with a value corresponding to a certain fraction of the Leader's account value (Leader Update Percentage) and a corresponding trade has been created in a following User's account, then the hybrid platform may buy or sell for the following User's portfolio a corresponding quantity of the same asset in the same Asset Exchange with a value equivalent to a fraction of the User's account value (User Update Percentage), with the amount of asset bought or sold corresponding to the percentage of the User's portfolio that is currently following the Leader's account trading activity as given by: (User Update Percentage)=(Leader Update Percentage)*(Follower New Percentage)
12. If the Leader exits an open trade by selling all of a asset that was originally bought on a particular Asset Exchange and a corresponding trade is open in the following User's account by nature of following the Leader, the corresponding trade may be closed in the following User's account.
13. Over time, as trades are opened and closed by the Leader, the overall percentage of the Leader's portfolio that controls the allocated percentage of the following User's portfolio (Follower New Percentage) may grow, until 100% of the portion of the User's account balance that is allocated to follow the Leader is controlled by the trading action performed by the Leader. In this case the change in value of the User portfolio (User Portfolio Rel Value) may follow the change in value of the Leader portfolio (Leader Portfolio Rel Value) as determined by the percentage of the User portfolio that is currently allocated to the leader (Follower New Percentage) according to:

(User Portfolio Rel Value)=(Leader Portfolio Rel Value)*(Follower New Percentage)
14. When a User desires to stop following a Leader and disable automatic trading and portfolio balancing that occurs due to following a leader, the user may “unfollow” the leader by selecting an appropriate option, e.g. by pressing an unfollow button next to the Leader's name on the Leader's profile page in the Client Software running on a User Device. At the time of unfollowing the leader, the User may be presented with an option for implementing the unfollowing: Per option (a), the user may elect to automatically close one or more or all trades that are currently open and that correspond to the follow relationship with the leader, e.g. selling the selected assets that were originally bought by the leader. Per option (b), the User may elect to leave one or more of the trades that were associated with the follow relationship with the leader open, so that at a later opportune time the User may close each open trade individually at a time that the User determines to be most opportune.
15. Using the techniques described herein, the following and unfollowing of a Leader is analogous to the buying and selling of a asset index, where the composition of that asset index is controlled by the Leader.

### A Conditionally Scripted Sequence of Buy/Sell Operations in a Hybrid Social Media/Asset Trading Platform

In various embodiments, a user may construct a conditionally scripted sequence of buy/sell operations that may execute the specified trades programmatically. A trade within various embodiments of the hybrid platform corresponds to any sequence of actions that results in a fully reversed series of asset transactions within a Asset Exchange. The following are illustrative, but not limiting examples of a trade:
1. The sequence of buying a certain quantity of a asset and then selling the same quantity of the same asset (at possibly a different price) corresponds to a single complete trade
2. The sequence of buying a certain quantity of a asset, then selling a lesser quantity, buying a different quantity, and then selling the entire outstanding quantity of a digital asset corresponds to a single complete trade.

To construct a trade, a platform user may specify a series of buy/sell operations, each of which may be separated by a Conditional Logical Expression that determines whether and/or when the subsequent buy/sell operation(s) in the process may be executed. For example:
3. The Conditional Logical Expression may evaluate whether the price of the asset to be bought or sold has crossed a specified threshold value.
4. The Conditional Logical Expression may require that the user must manually press a button using the Client Software in order to trigger initiation of subsequent steps
5. The Conditional Logical Expression may evaluate any other data available to the hybrid platform that can be specified via the client software.

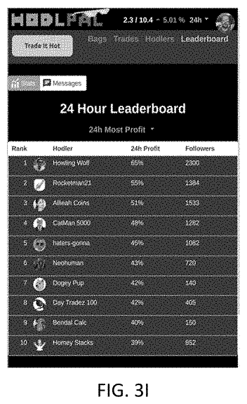

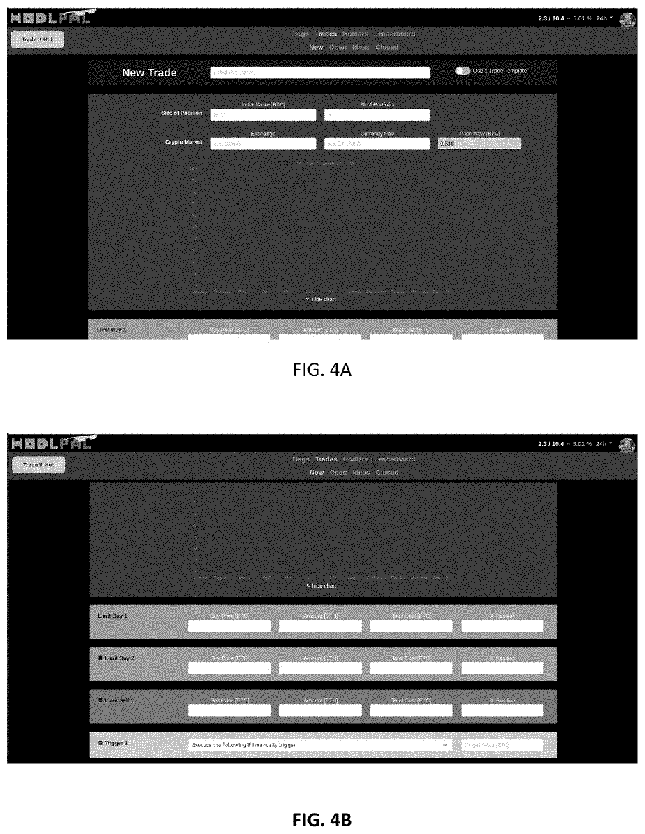

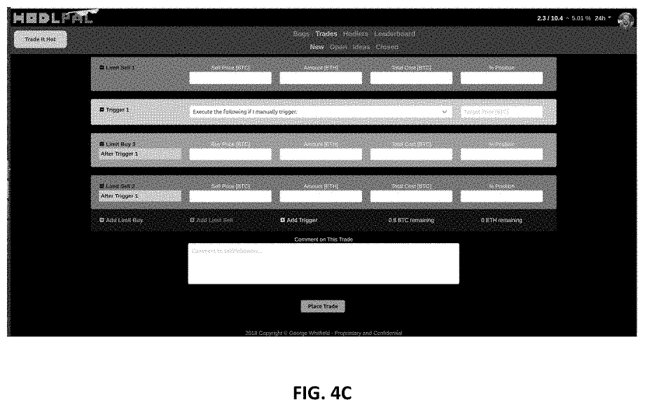

In addition to the ability to conditionally script logic associated with buy/sell operations of the trade, the User may also have the option to attach a comment to the trade, starting the discussion thread that can be attached to the trade. Other users may subsequently have the ability to comment on the discussion thread and express their like/dislike of the trade and buy/sell operations or conditional logic contained therein. FIGS. 4A-4C depicts a Graphic User Interface (GUI) that may be used to construct one or more conditionally scripted sequences of trade (e.g., buy/sell) operations.

Automated and Semi-Automated Execution of Trades Based on Peer Actions within a Hybrid Social Media/Asset Trading Platform

As described above, peer relationships within various embodiments of a hybrid platform may be used to construct a digital asset index via the automated execution of trades that are linked to Follower user accounts from Leader user accounts. Alternatively, in some embodiments, a user may elect to interrupt the automated following process by electing to be prompted for confirmation, whenever a Leader initiates a new trade or when a Leader initiates any buy or sell operation that occurs within a trade. The confirmation process may appeal to some Users that wish to maintain final control of any actions that are performed within their accounts while also benefiting from the opportunity to evaluate trading decisions that are made by Leaders. In effect, such Users may trade-off their ability to quickly follow a Leader (because the confirmation process may take more time than is required to automatically replicate a trade of a leader, potentially much more if the Follower does not respond immediately) with the amount of direct control that the User maintains over his or her account.

To implement semi-automated execution of Follower trades and to incorporate a confirmation step to be performed by the Follower, an extra step is added to the procedure that would otherwise be performed for Follower trades that are executed when initiated by a Leader. After the Leader initiates the trade and the command is sent to the Back-End Server (or DAPP), and after the Back-End Server (or DAPP) queries the Database (or Blockchain) for all corresponding relevant Follower information, any follower who has elected to have the opportunity to confirm the Leader's trade is informed that a new trade has been initiated, via push notification from the Back-End Server (or DAPP) to Client Software running on the Follower's User Device. Such Followers upon checking the notification may be presented with details of the Leader's proposed trade and two selectable options (e.g., two buttons) to either accept or decline the proposed trade. If the trade is declined the User may still reconsider the possible trade in a section of the User's Client Software that may store Trade Ideas.

Once the Follower confirms acceptance of a trade that is performed by a Leader, the Client Software may send confirmation to the Back-End Server (or DAPP), after which point the remainder of the Follower trade may proceed as it otherwise would in an automated fashion, contacting the Asset Exchange to initiate the buy or sell operation and subsequently polling the exchange to determine when the order has completed. A user may elect to follow more than one leaders regarding a particular asset. In these cases, the user may elect to be notified of a trade for consideration only after a selected number of leaders (e.g., 2, 5, etc.) have executed trades in that asset.

The leader-follower relationships can be established on a platform in a dynamic manner. At any time, a user may request to become a follower of another user, making the other user a leader. The user newly designated a leader, however, may be following another user, i.e., another leader. Similarly, at any time, a particular follower may choose not to follow a particular leader or, a particular leader may decide not to allow a particular follower to continue as a follower. Just as a leader can have more than one follower, a follower can have more than one leaders, not only for different asserts, but even the same asset. Moreover, the leader-follower relationship can be asset-specific, as described above, or it can be generic, i.e., applicable to a leader's entire portfolio.

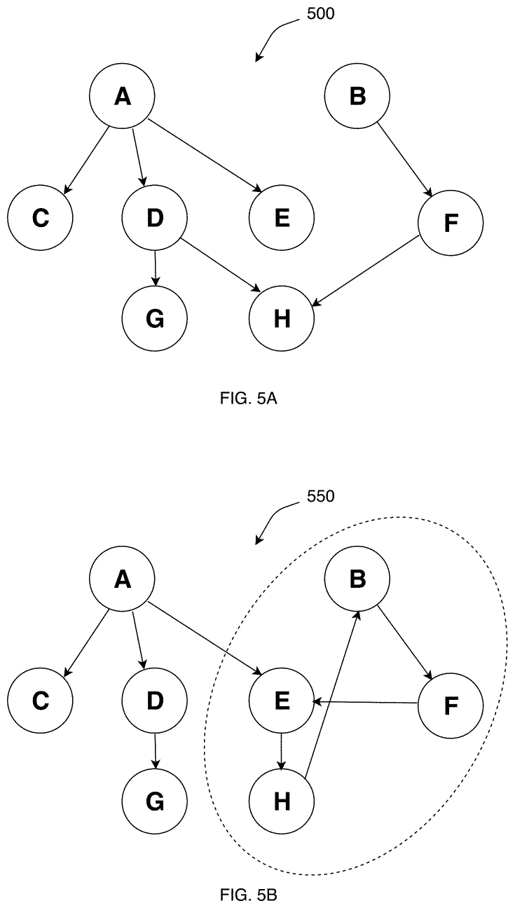

This dynamic and complex nature of the leader-follower relationship can lead to cycles, which can cause a system malfunction, as illustrated with reference to FIGS. 5A and 5B. In FIG. 5A, graph 500 shows that users A and B are the designated leaders for a particular asset. Users C, D, and E are direct followers of the leader A, and user F is a direct follower of leader B. Users G and H are direct followers of user D who, therefore, is both a follower (of user A) and a leader (of users G and H). User H is additionally a direct follower of user F and, as such, user F is also both a follower (of user B) and a leader (of user H). Users/followers G and H are also the followers of leader A, and follower H is additionally a follower of leader B, as well.

In various embodiments, the hybrid platform continually maintains and updates a graph, such as the graph 500, for each asset, representing the leader-follower relationships for that asset. If a leader-follower relationship is generic and not specific to any asset, that relationship is represented in all graphs. Any time a platform user establishes a new leader-follower relationship with another user, or terminates an existing relationship, the hybrid platform adds to the applicable graph(s) (as needed) or removes from such graph(s) one or more nodes corresponding to the users involved in the new or terminated relationship. In general, a node needs to be inserted for a user only if the user has no prior designation as a leader or as a follower. A new leader-follower relationship is represented by a directed link from the node for the user designated leader to the node for the user designated follower. In some embodiments, a directed link between a leader and a direct follower of that leader indicates a percentage of the direct follower's portfolio that the direct follower wishes to replicate according to the leader's portfolio. In various embodiments, the graph update(s) are performed in real time, e.g., within a few minutes, a few seconds, a fraction of a second, a few milliseconds, etc.

Each time the graph is updated, a processor traverses the graph detecting whether any cycles are present therein. In various embodiments, the detection of cycle(s) in each updated graph is performed in real time, e.g., within a few minutes, a few seconds, a fraction of a second, a few milliseconds, etc. A cycle is present if a traversal along a sequence of directed links starting from any node in the graph would return to that node. The graph 500 does not contain any cycles, but the graph 550, shown in FIG. 5B does, as discussed below.

Graph 550, like graph 500, includes leaders A and B. Here again, users C, D, and E are direct followers of leader A and user F is a direct follower of leader B. User G is a direct follower of user D, and user H is a direct follower of user E. In addition, user E is a direct follower of user F and leader B has elected to follow user H. This last relationship creates a cycle B-F-E-H-B. Thus, if the leader B performs a trade in a particular asset, that trade would be replicated for user F. User F's replicated trade would be replicated further on behalf of user E, and user E's replicated trade would be further replicated on behalf of user H. Thereafter, this trade by user H, that originated with leader B, would be replicated on behalf of user B. This cycle may continue indefinitely, until one of the users in the cycle becomes ineligible, e.g., that user has no funds available to execute the trade.

This is not an intended result of the leader-follower relationships and can be prevented by constructing a graph, as described above, and by detecting cycles therein by traversing the graph, e.g., in the depth first order or breadth first order. It should be understood that mere designation of a user as both a leader and a follower does not necessarily create a cycle. For example, the graph 500 does not contain any cycles, but users D and F are both followers and leaders. In various embodiments, the last new leader-follower relationship that created a cycle is terminated and the users involved in that relationship may be notified accordingly.

In some embodiments, the follower in the last new leader-follower relationship that created the cycle, e.g., the follower/leader B, is tagged. While recursively traversing the graph, when a tagged node is revisited, the recursive traversal is terminated, so as to avoid the unintended result described above. The users involved in that relationship may be notified accordingly.

### A Graphic User Interface for Review, Acceptance, and Execution of Trades of Assets

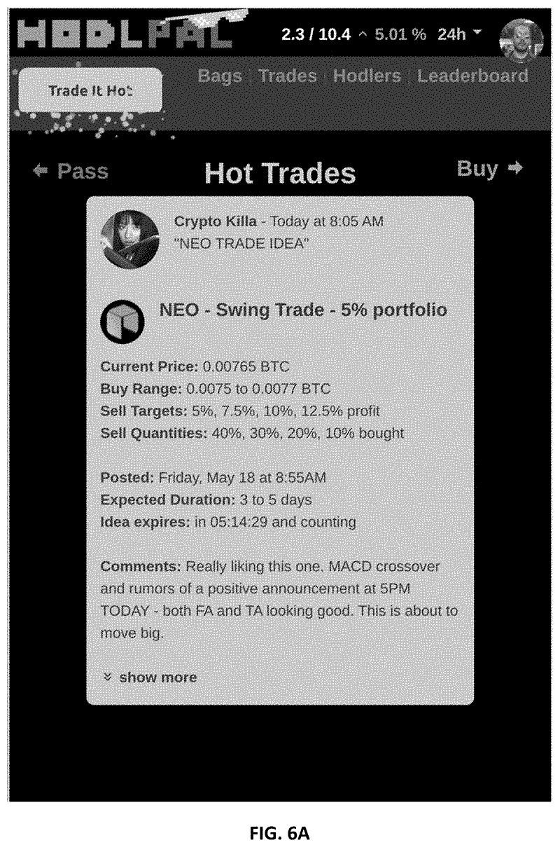

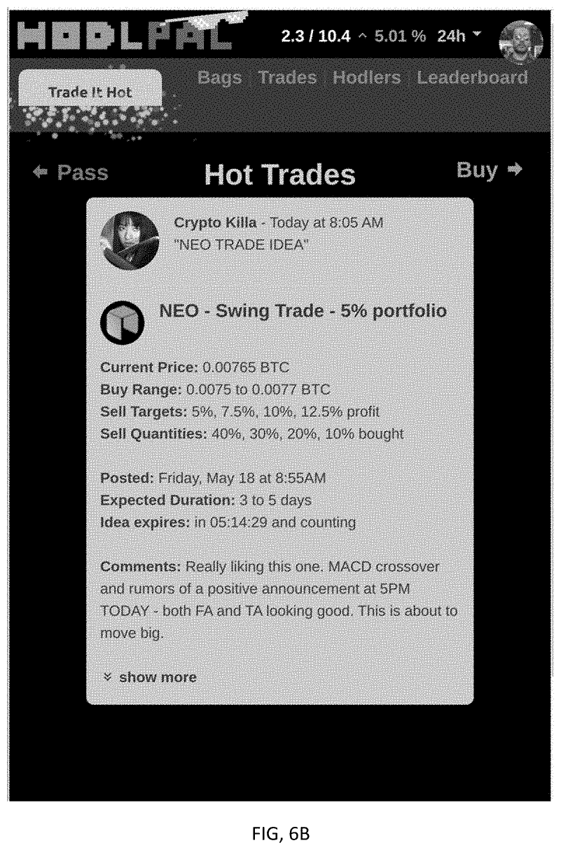

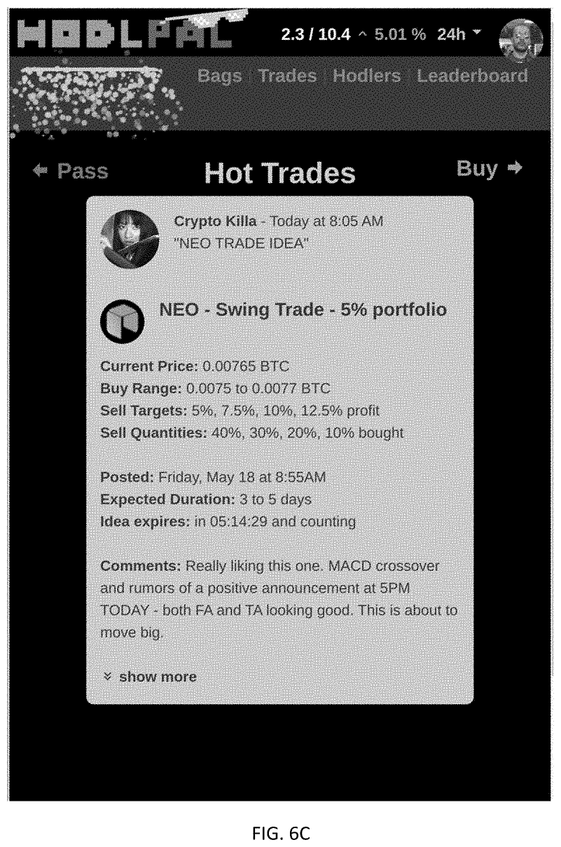

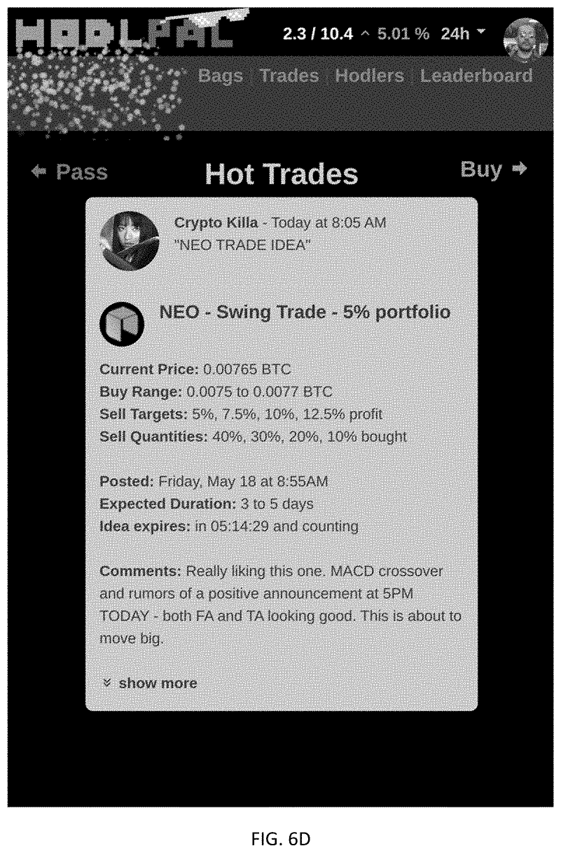

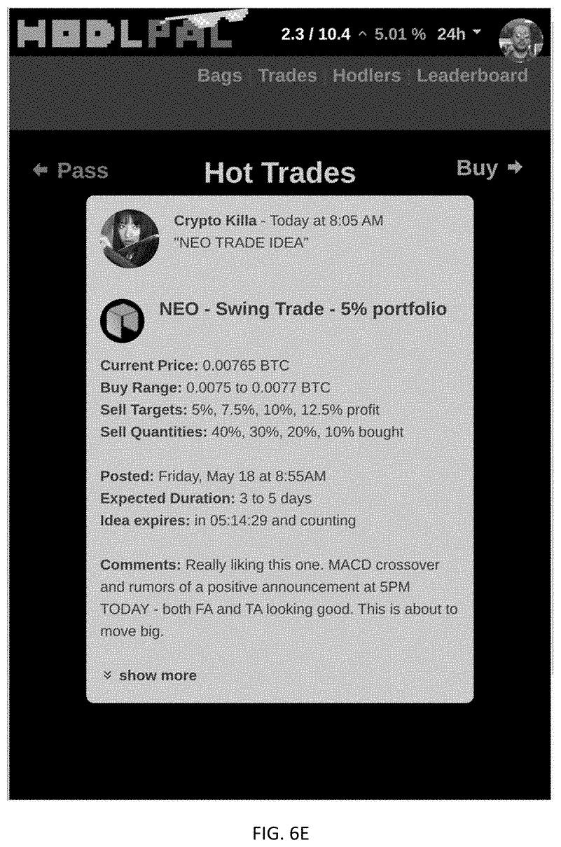

When a User has multiple Trade Ideas pending in his/her account that would require confirmation in order to execute (e.g., because the User has followed one or more Leaders and elected to receive confirmation before replicating a Leader's trades), the User may desire to quickly and efficiently review each Trade Idea, confirming the User's decision on each. An embodiment of a graphic user interface for such review and approval is described below where the User is presented with information corresponding to each Trade Idea, one Trade at a time, and in a serial fashion. In one embodiment, the user clicks a button on the user interface, “Trade It Hot,” and then a different user interface called the Hot Trades page appears where certain extraneous features of the GUI disappear (e.g. the Trade It Hot button may disappear, sub-levels of the navigation bar may disappear) and the user is presented with a single “data card” containing information about the first trade to be considered. The label “Hot Trades” is illustrative only, and any other label may be provided in different embodiments. As shown in FIGS. 6A-6E the disappearance of the Trade Hot button and the appearance of the data card may be animated. In some embodiments, only the disappearance of the Trade Hot button is animated and the Data Card is immediately displayed so that the User can begin considering details of the first trade without delay.

In some embodiments, the data card contains a concise description of summary information describing the Trade Idea to be considered as well as interactive features, e.g., buttons using which reveal more detailed information on the trade if so desired. The summary information may include:
1. Name and profile picture of the Leader who created the Trade Idea
2. Percentage of the User's portfolio that is following the Leader
3. Name and icon image of the asset to be traded
4. Amount of asset proposed to be bought
5. Buy target price(s) of the asset
6. Subsequent sell target price(s) that may be specified for the asset
7. A summary of any conditionally scripted sequence of buy/sell operations that may be
specified for the asset
8. Target profit of the trade as a percentage of initial buy price
9. Initial discussion comments posted by the leader and/or comments posted by other Followers in response to the leader. For example, if a particular follower posts a comment in response to the Leader's Trade Idea and that particular follower's comment is “up-voted” to become the most popular response to the Leader's Trade Idea, then that most-popular comment may be displayed on the high-level summary card so that the User may quickly evaluate it along with other information.
10. A summary of the overall “social score” of the trade may be placed on the data card as a numerical value corresponding to the number of likes and dislikes that the trade has received by other Followers of the trade
11. A countdown for a timeframe specified by the Leader, within which the Leader considers the Trade Idea to be actionable
12. The Leader's expected trade duration, i.e. how long the Leader expects to keep the trade open

Once the User has examined and evaluated a data card, the User may then either accept or reject the Trade Idea. If the User accepts the trade idea, it is executed as described earlier. If the User rejects the Trade Idea, it is removed from the queue of Trade Ideas to be immediately evaluated and optionally placed at the back of a cyclic queue of Trade Ideas that may be reviewed by the User.

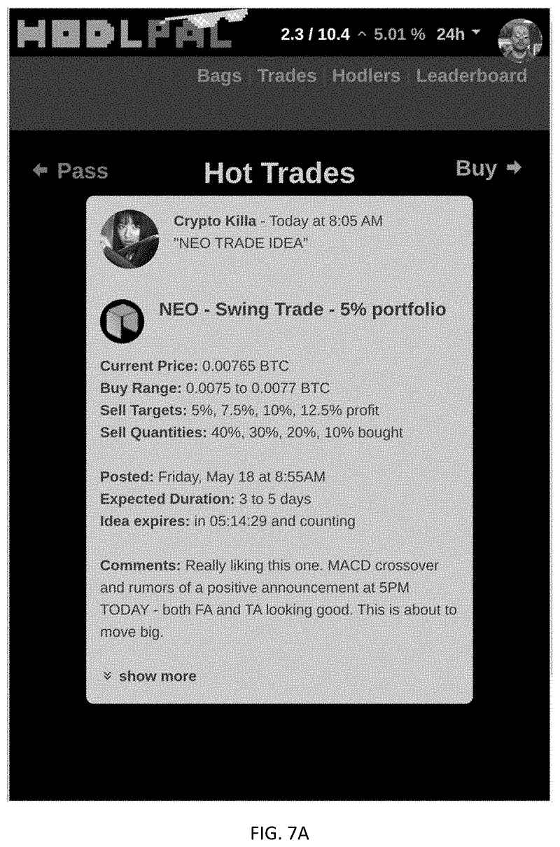

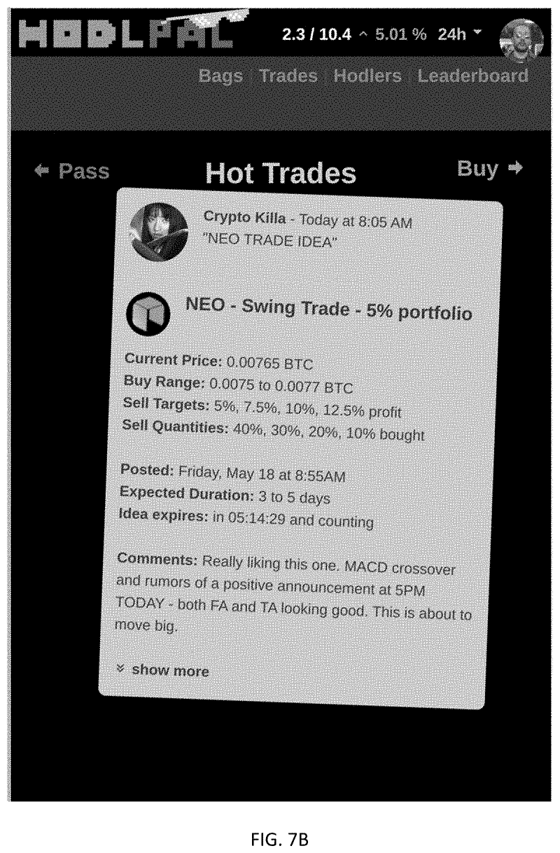

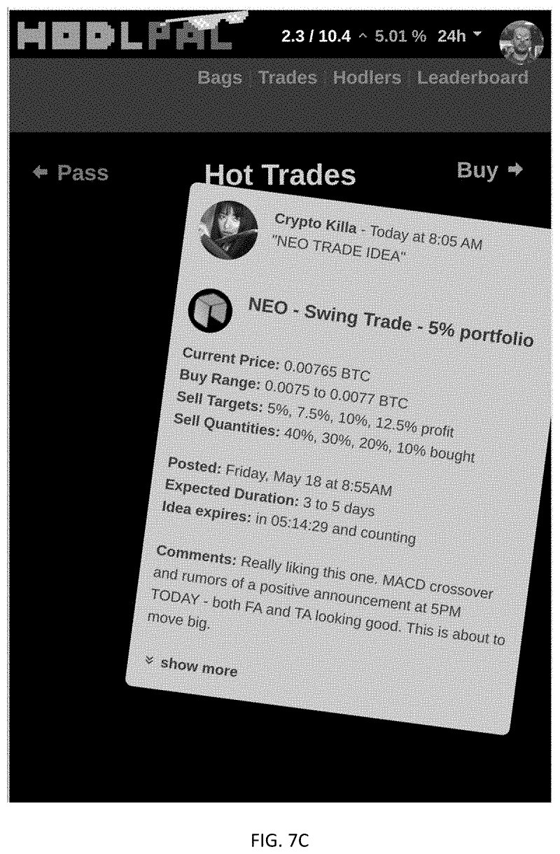

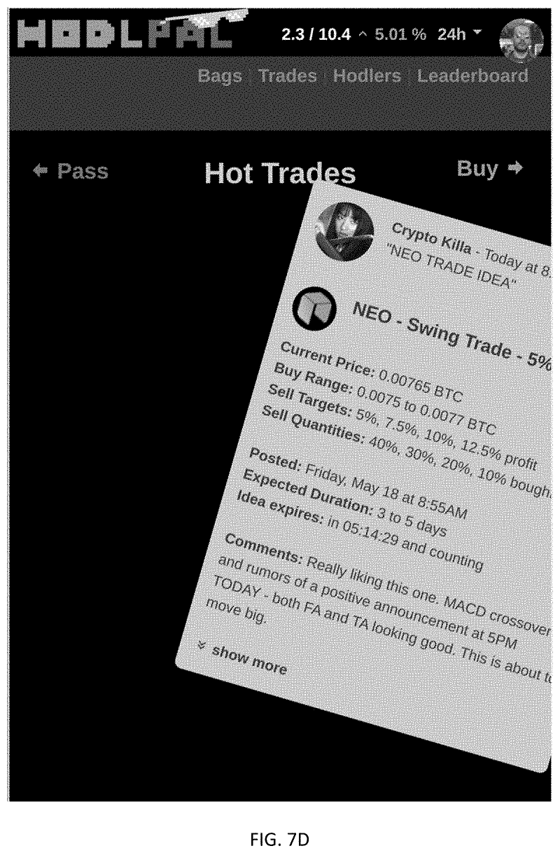

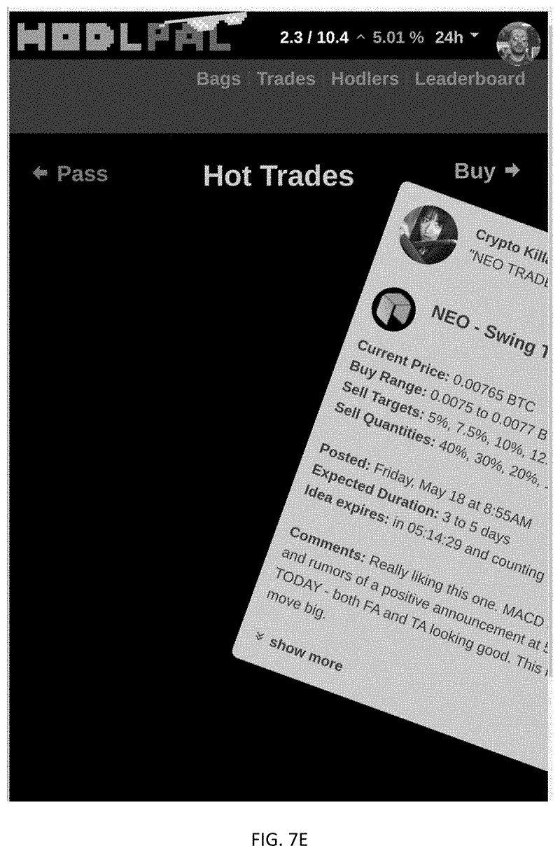

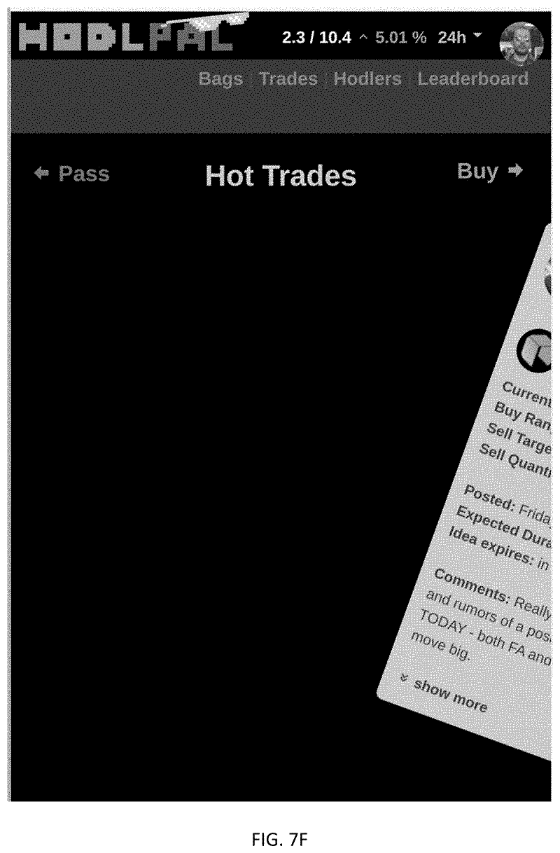

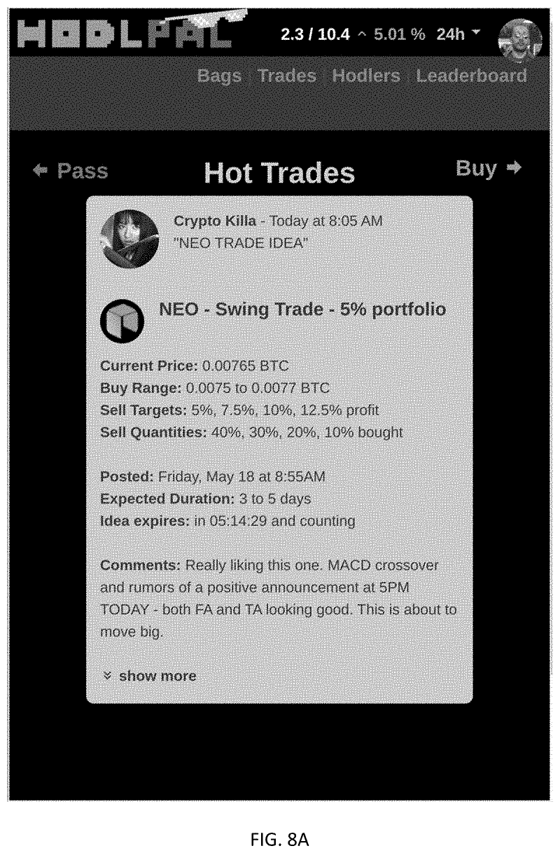

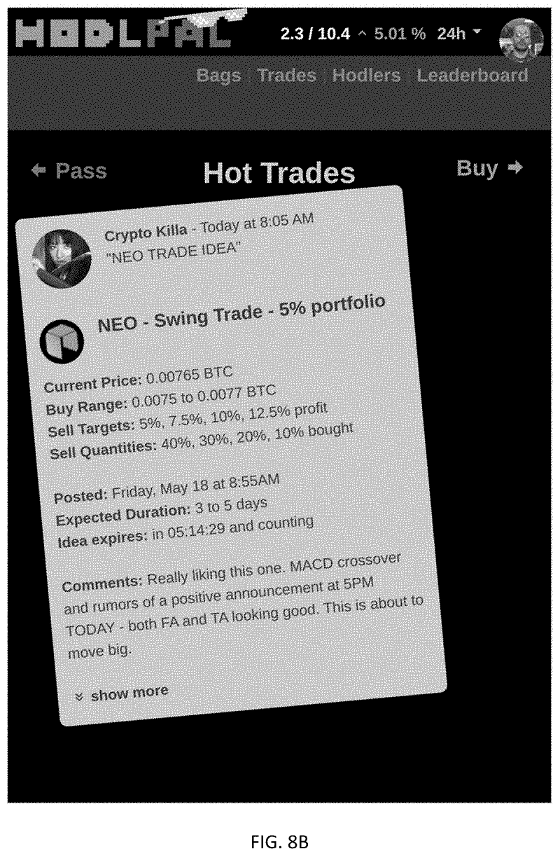

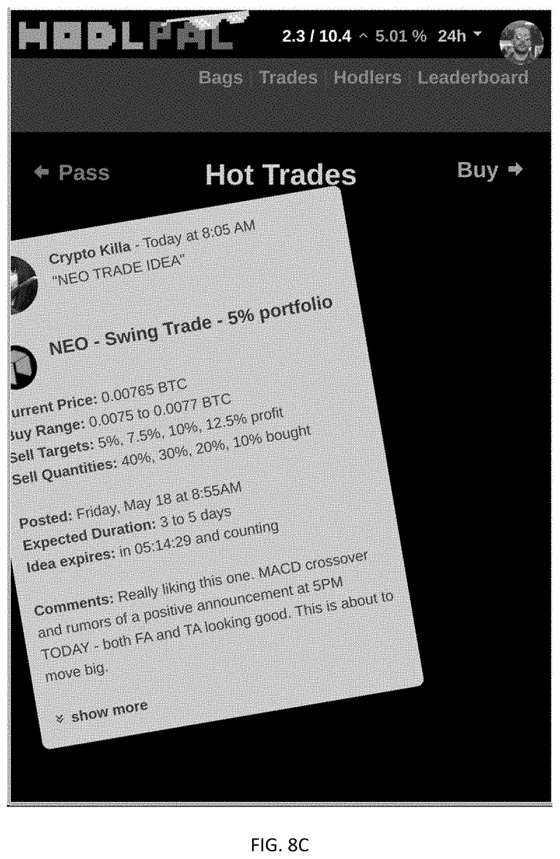

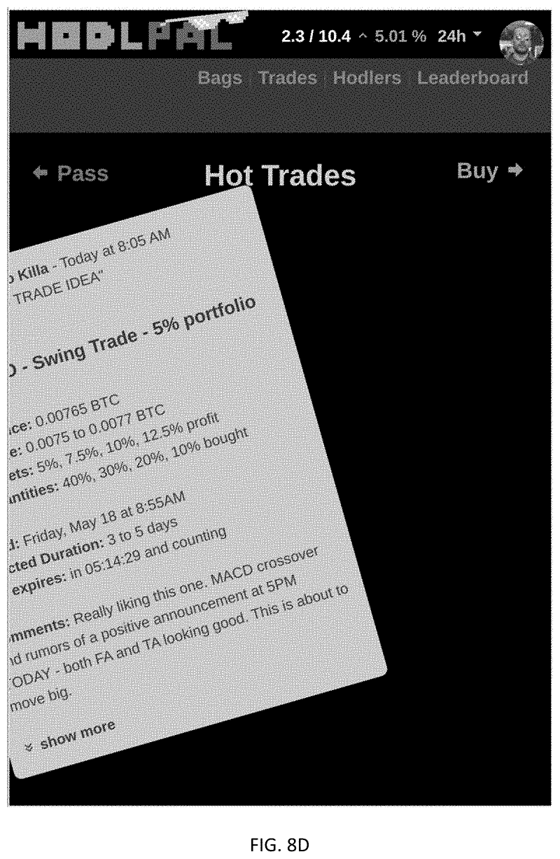

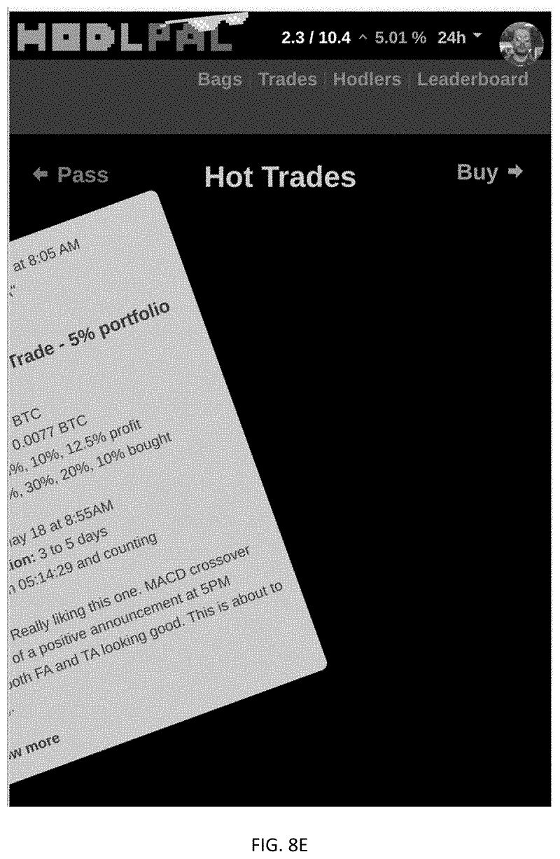

To Accept the Trade Idea, the User may either click “Accept” or optionally “swipe right” to drag the entire data card off of the right side of the screen. To Reject the Trade Idea, the User may either click “Reject” or optionally “swipe left” to drag the data card off of the left side of the screen. With reference to FIGS. 7A-7F and 8A-8F, the data card and associated swiping motions are shown in multiple frames that illustrate animation of the GUI that is associated with the swiping motion. First, swiping right is shown in FIGS. 7A-7F as a way of accepting a trade. Then, swiping left is shown in FIGS. 8A-8E as a way of rejecting a trade. In some embodiments, swiping left would accept a trade and swiping right would reject it.

Optionally, as the User is in process of swiping to the right or swiping left, a visual indication of the action being performed is overlaid on top of the data card, e.g. displaying in large green letters “ACCEPT” overlaid with the card while swiping right or displaying in large red letters “REJECT” overlaid with the card while swiping left. Alternatively a large green check-mark may be displayed while swiping right and a large red X while swiping left.

Once a Trade Idea has been either accepted or rejected, the next trade Idea in the queue of Trade Ideas for the User to consider may be presented in a new Data Card. In the context of asset trading this GUI represents powerful way to rapidly evaluate and execute Trade Ideas that are concisely summarized in a focused, serial manner. A single swipe-right gesture may result in the buying and selling of a substantial amount of assets as has been predetermined by the User controlling the interface.

In case a user is concerned about the possibility of “accidental gestures”, the user may have the option to delay any subsequent automated action after swiping by a user-specified amount of time (e.g. 10 seconds). During that delay period, a notification box may appear at the top or the bottom of the User Device screen, stating what the user's action was “order accepted” or “order rejected” and a button presenting the user with the opportunity to “Undo”. If the user clicks “Undo”, no action is taken and the user may again be presented with the same card for re-evaluation. If the user does not click Undo and the delay time period elapses, the Trade Idea may be executed in the User's account.

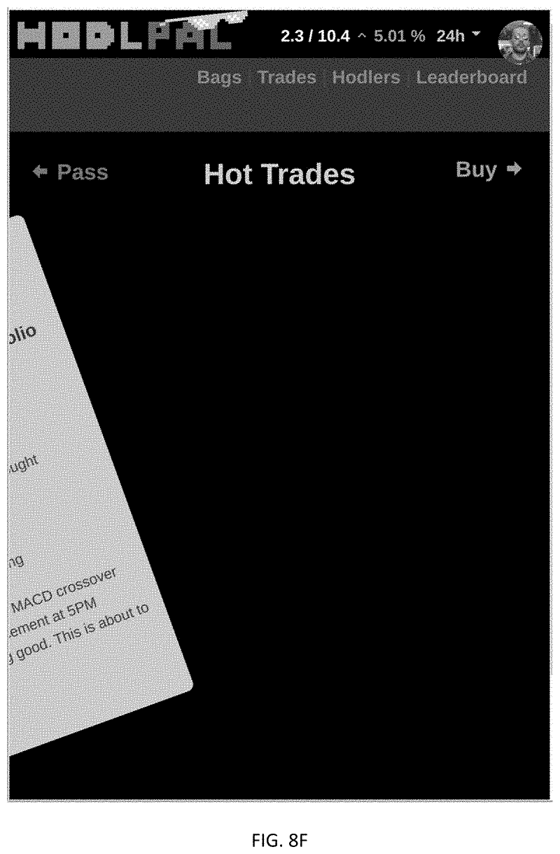

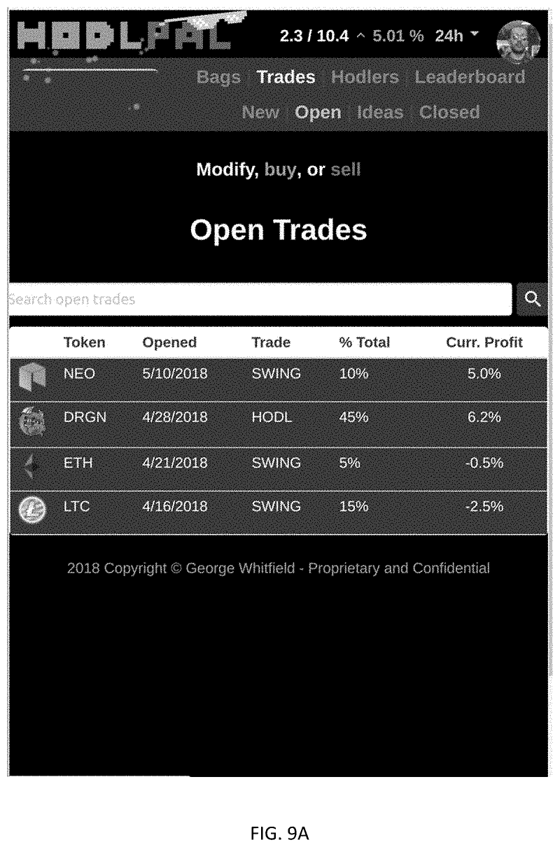

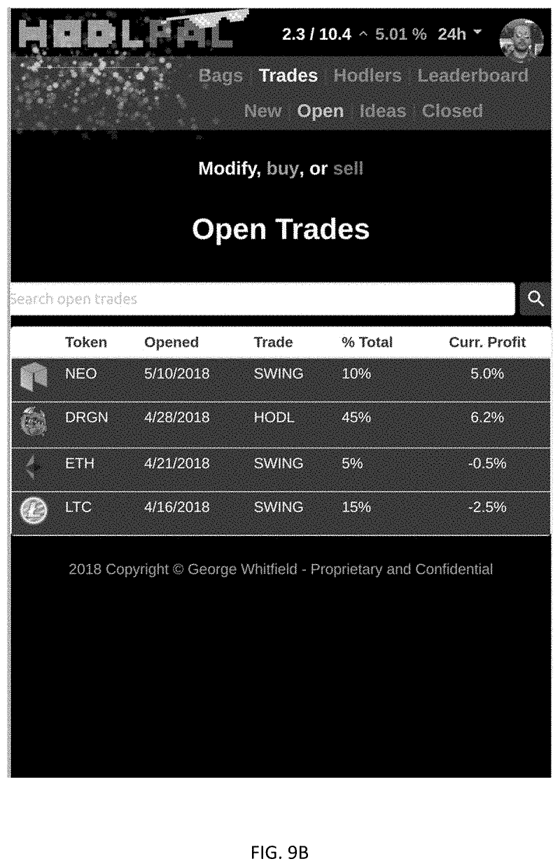

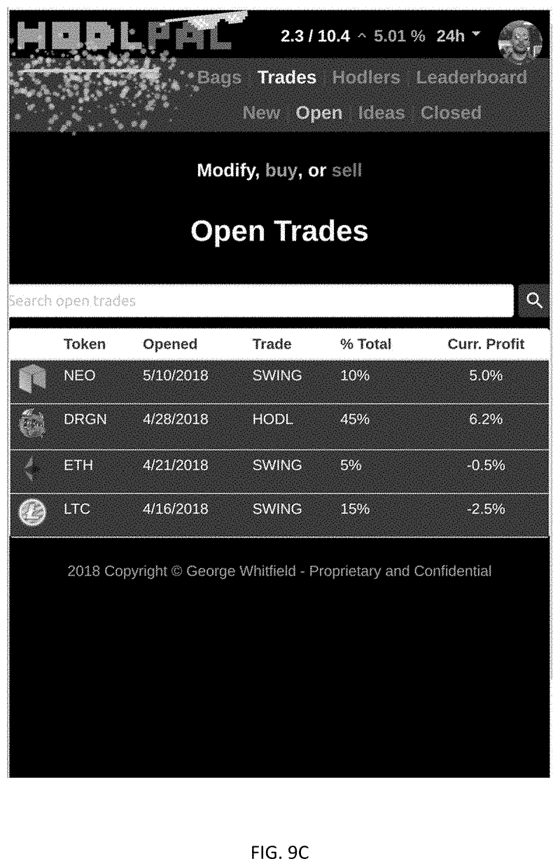

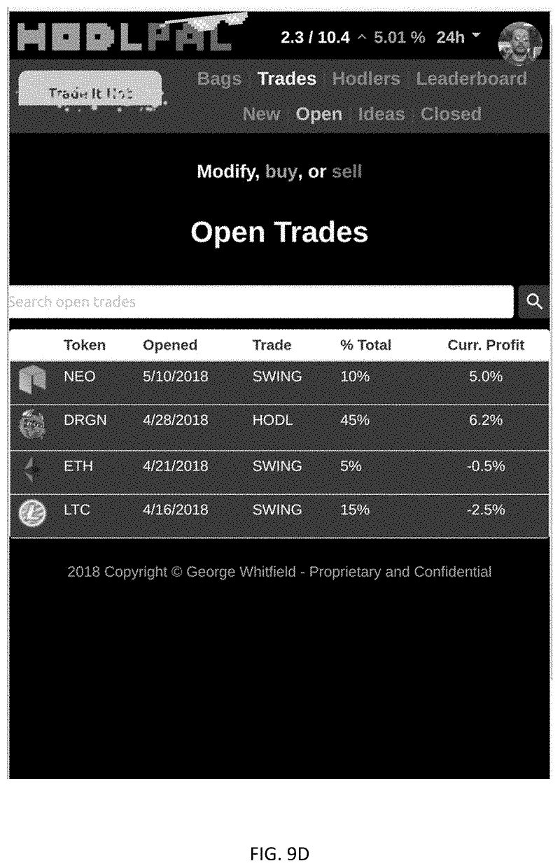

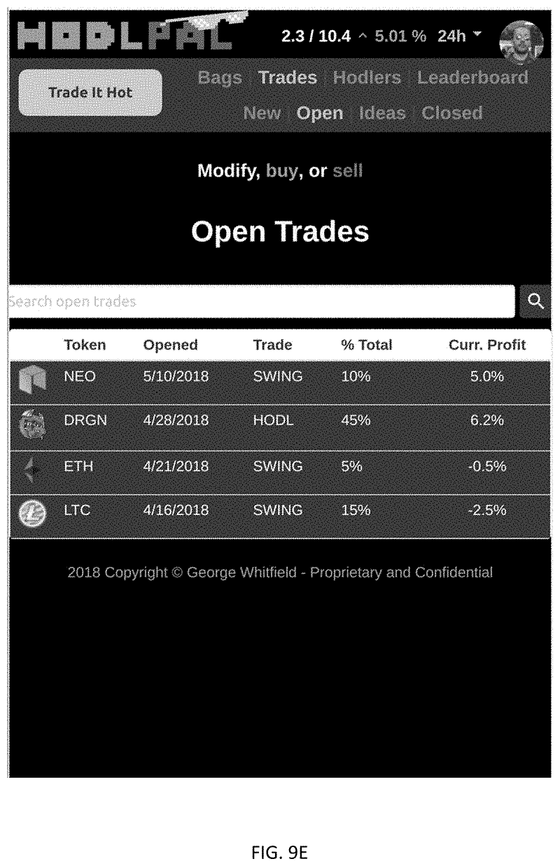

The order in which Trade Ideas are presented to the user may be determined by a range of factors such as the order in which the Trade Idea was created by a Leader, proximity of the asset price to a critical threshold associated with initiation of the Trade Idea, or a Leader-specified timeframe within which the Trade Idea is considered by the Leader to be actionable. When the User decides to resume “normal” operation of an embodiment of the hybrid trading platform outside of the “Trade It Hot” feature, the User may click on a navigation feature at the top of the screen to go to a different page. Upon navigating away from the Hot Trades page, the “Trade It Hot” button gradually reappears at the top of the page in an animated fashion and remains at the top of the page as the User browses other pages of the Client Software as a reminder of this powerful feature that is available to the User with a single tap of a button. FIGS. 9A-9E shows gradual reappearance of the “Trade It Hot” button.

A Graphic User Interface for the Historical Display of Asset Orderbook Density Overlaid with Asset Price Charts

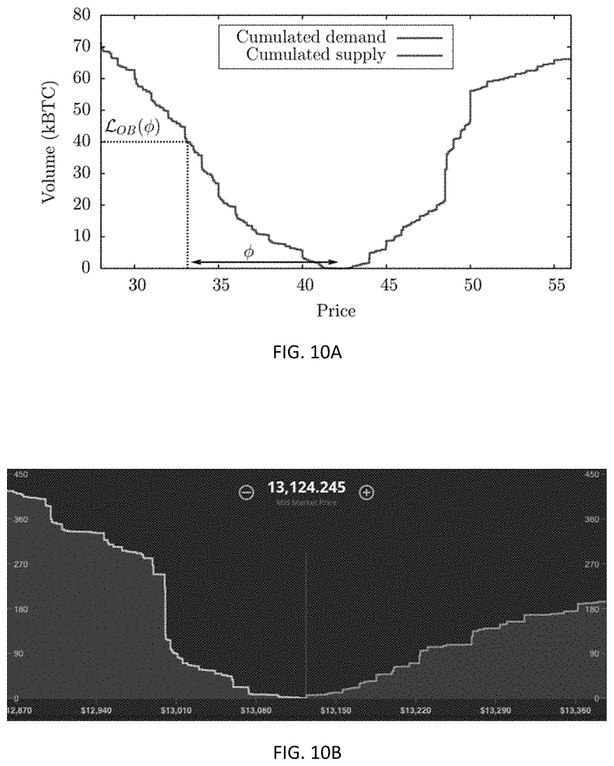

Orderbooks for financial markets are typically graphically represented at an instantaneous point in time as a chart illustrating the cumulative value of orders placed in that financial market (i.e. cumulative supply and cumulative demand), from the current bid price up to the highest limit sell order in the market and from the current ask price to the lowest buy order in the market. For most Asset Exchanges, an orderbook chart such as this can be displayed, showing the contents of the orderbook at the present time. Examples of such orderbooks are in FIGS. 10A and 10B.

In current asset markets, the historical contents of the orderbook are rarely if ever accessible. Many Asset Exchanges permit the downloading of the entire orderbook via a Asset Exchange API. In this case, a software product running on a computer server may be created to store the historical contents of the orderbook over time to an appropriately structured log file (e.g. in hierarchical data format for large amounts of time series data) or a database (SQL based databases can work but due to the volume of data a database optimized for time series data such as eXtremeDB, Graphite or some other NoSQL based database may perform better) so that they may be retrieved and re-examined at a later date. However, the instantaneous manner in which orderbooks are normally displayed is insufficient for a summary review of orderbook data that has been collected over time.

Economic models of financial markets relate the contents of the orderbook to the market value of the underlying asset, and certain theories state that the distribution of orders within the orderbook may be indicative of price distribution may be indicative of buying or selling pressure. Hence, it would be instructive to relate changes in the distribution of prices in the orderbook over time to changes in the price of a asset over time, to see whether such theories hold true and to determine whether the change in distribution of orders in an orderbook has any measurable correlation to change in price of the asset.

The theory of “technical analysis” of financial markets states that future price action may be predicted in part by historical price action according to certain generally observed trends or patterns that have been noticed to occur in many markets. While such rules do not strictly hold, the fact remains that psychology and investor perception plays an important role in trading decisions that are made in the market. Given that market sentiment may persist over time and may be reflected in some form by the distribution of orders in the orderbook, the simultaneous visualization of the historical contents of an orderbook overlaid with the asset price over time can be of direct relevance to the assessment of “technical analysis”.

Hence, a specified display panel is described that can simultaneously display the historical distribution of orders within an orderbook over time along with the asset price over time, in a single chart. In some embodiments, this new type of GUI is constructed as follows:
1. Record the entire contents of the orderbook continuously over the entire or a specified time period to be shown on the historical chart, at sufficiently high frequency to provide enough points to provide the desired resolution on the chart to be created. In some embodiments, the orderbook is collected at a higher frequency than the frequency at which it may be displayed along the time-axis and then the data is averaged or decimated, thereby reducing fluctuation resultant from short-order price movement).
2. At the same time, record the asset price continuously over the same time period at sufficiently high frequency or higher to support the desired chart resolution with support for price averaging, decimation, or construction of candlestick charts as may be needed.
3. For each time-step, perform a mathematical function on the entire orderbook, which is a chart of the cumulative distribution of bid and ask order volume as a function of price. Compute a continuous derivative of the orderbook order volume with respect to price, separately for the bid and ask orders. This results in a new chart that represents bid and ask order density as a function of asset price.
4. Repeat this process for all orderbook data that has been collected in the timeframe of the chart that is to be plotted, computing the derivative of cumulative order volume with respect to price and providing as output order density as a function of asset price at every point in time.
5. Resample the order density data over its range of price et at every point in time to be shown in the chart, converting it from a continuous representation of order density vs. price to a discrete representation of order density vs. price, according to a fixed amount of price discretization size that corresponds to the desired resolution to be used for display on a resultant chart (to be overlaid with the price of the asset). Alternatively, this resampling may be performed prior to computation of the derivative of cumulative order distribution vs. price, which may increase subsequent computation of the derivative. Resampling has the benefit of aligning orderbook data that at adjacent points in time, such that every point in time has a known value of orderbook density at every price over the range of interest recorded by the orderbook, and adjacent points in time may also show orderbook values at the same price (if it is included in the range originally provided by the orderbook data).
6. Resample the order density data at over the entire timeframe to be displayed at every discretized price level to be shown in the chart, creating points that are evenly-spaced in time and smoothing out clusters or gaps in time series of the originally sampled data set. The resultant data set is a grid of values evenly spaced in time and evenly spaced asset price, where the value of each grid element represents the density of the orderbook at that particular point in time and that particular price.
7. Plot the historical value of order density vs. price and time as a color intensity map on a chart, overlaid with the asset price (price being shown either as a line chart, a candlestick chart, or some other form of price chart). In constructing the color intensity map as embodied in the drawings, the color of the location of the map (red or green) indicates whether buy or sell orders are present at that price and at that point in time and the intensity of the location of the map (faint or strong) indicates the density of those buy or sell orders at that specific price and that specific point in time on the chart. Alternatively, the alpha or saturation value of the color at that point on the chart may be modified to represent density. Alternatively, the range of order density that are visualized on the chart may be mapped to any selected spectral progression of RGBA numerical color values, where RGBA stands for red, green, blue, and alpha. Furthermore, for the purpose of constructing the chart, the order density color map vs. price and time may be averaged, smoothed, or otherwise interpolated between discrete datapoints on the chart for the purpose of constructing a visually smooth representation of order density over the entire region of price and time.

The combination of asset price plotted together with a visualization of the historical order density within the orderbook can provide new insights into interpretation of technical analysis and the possible influence of orderbook density upon price action. For example, the presence or absence of supposed “support” or “resistance” lines may be confirmed by features evident in the historical order density color map. The historical shape of this color density map may influence an analyst's interpretation about how the price may move in the future based on previously observed trends, and a machine learning algorithm may further be trained to try to identify and exploit such trends as at times might not be evident to a human analyst.

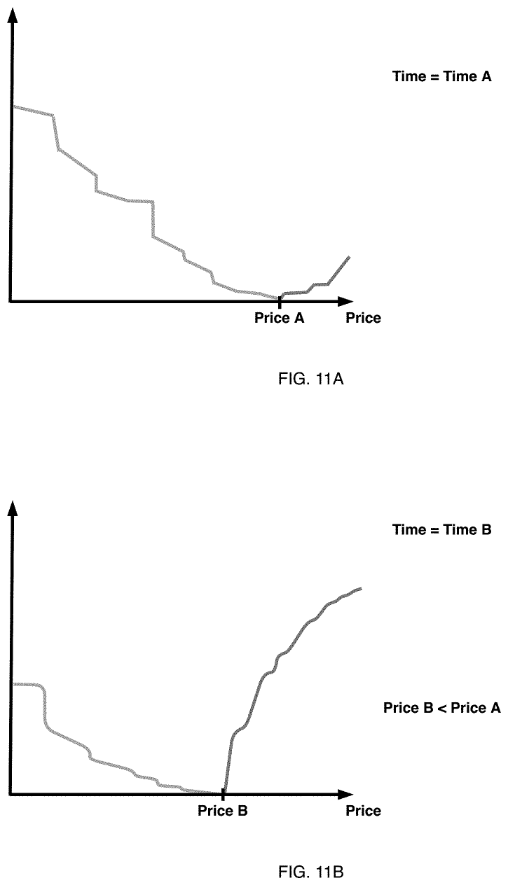

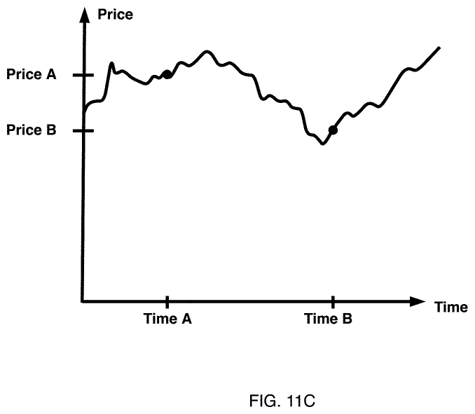

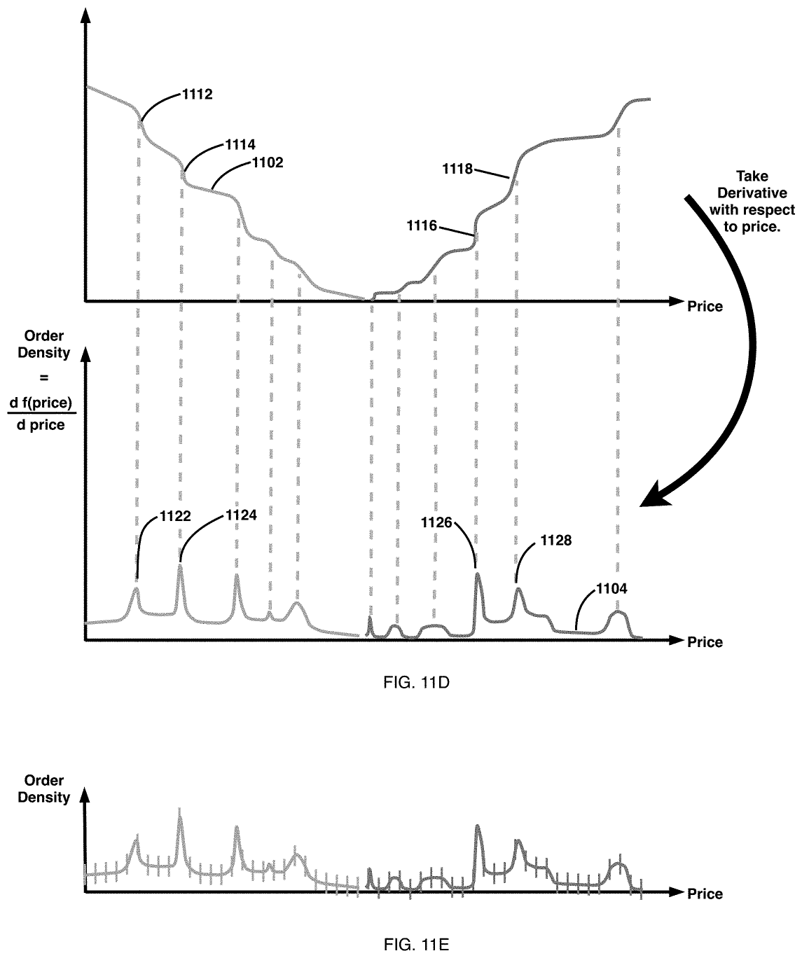

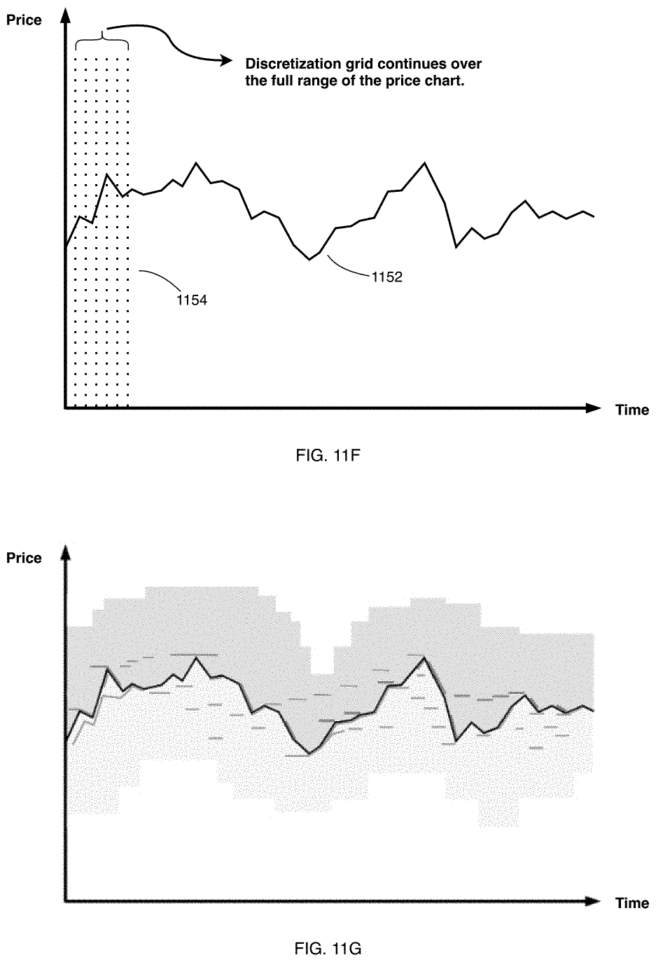

FIGS. 11A-11G illustrate the above procedure for computing the order density color map and overlaying it with the price chart. In particular, FIG. 11A shows the cumulative order value (i.e., volume) for a particular asset as a function of asset price at a certain time (Time A). FIG. 11A shows cumulative order values/volume for that asset as a function of asset price at another time (Time B). The green portion of the charts shows the bid or buy volumes and the red portion of the charts shows the ask or sell volumes. A trade would occur at a price for which both the bid and ask volumes are nonzero. In FIG. 11A, that price is denoted Price A and in FIG. 11B, such a price is denoted Price B. FIG. 11C shows the prices of the asset at which trades occurred as a function of time, e.g., over the time window from Time A through Time B.

In FIG. 11D, the chart 1102 shows cumulative order values/volume for the asset under consideration as a function of asset price at some selected time, and chart 1104 is a price derivative of the cumulative order/value, yielding order density. The high-slope regions (e.g., 1112, 1114, 1116, 1118) of the chart 1102 correspond, respectively, to spikes or peaks (e.g., 1122, 1124, 1126, 1128) of the chart 1104. The derivative computation may be performed at several times within the selected time window over which the price chart (shown in FIG. 11C) is generated, yielding an ensemble of charts 1104.

FIG. 11E shows that an order density chart (e.g., chart 1104 shown in FIG. 11D) is discretized over selected price points within the price range corresponding to the selected time window. This yields a number of discretized order densities, each corresponding to a particular price point in a set of price points, and all of these discretized order densities corresponding to a single particular instance of time. The discretization may be repeated for all order density charts in the ensemble, where each chart corresponds to a different time in the time window. This yields a number of discretized order densities, each corresponding to a particular price point (in a set of price points) and also to a particular instance of time in the time window. In general, if the price range includes P price points and the time window includes T time instances, there would be P×T discretized order densities.

In FIG. 11F, a price chart 1152 (such as the price chart 1102, shown in FIG. 11C) is plotted. A price-time grid 1154 is overlaid on the price chart 1152. In some embodiments, even though the price-time grid is overlaid, it is not displayed, e.g., by using a color that is the same as the background color. In other embodiments, the grid is displayed but at a lower brightness or intensity than that of the price chart 1152. In FIG. 11G, where the price-time grid is overlaid but is not displays, each one of the P×T discretized order densities is mapped to a respective grid point on the price time grid.

Then an optical property (intensity, in FIG. 11G) of a respective pixel at each grid point is set according to the respective discretized order density. In various embodiments, the intensity, saturation, and or a red-green-blue-alpha (RGBA) value of the pixels are set according to the discretized order density values. In addition, in FIG. 11G, the discretized order densities associated with buy order volumes are shown in green and those associated with sell order volumes are shown in red.

### Hybrid Platform Data

Raw Data: During the operation of a hybrid platform, various types of data is collected from the actions of the platform users. This includes data regarding user trading habits, preferences, profitability, risk tolerance/aversion, timeframes and frequency of activity and engagement, leader/follower relationships, exchange accounts held, account balances, assets held, relative number of various assets and portfolio balancing strategy, community engagement, comments made, and likes or dislikes of particular trade ideas.
Derived Data: Raw data may be analyzed via a wide range of machine learning techniques (e.g. deep neural network) to gain deeper insight into correlative and predictive relationships that may be present.
Trading Engine: In general, the platform users place trades with a goal of maximizing their portfolio balances. As such, the collected data is particularly well suited for development of a trading engine that may imitate the behaviors of the highest performing users. In addition to the data collected by an embodiment of a hybrid platform, third-party data sets from conventional and widely used social media and financial platforms may also be included, to assess the impact of trends in broader media on the performance of individual traders.
Community Self-Organization: By exposing each user's actual profitability, various embodiments of the hybrid platform can create the opportunity to better monitor and improve one's own performance and benefit from the performance of others. An embodiment of the hybrid platform may identify which users are most profitable, and, in general, the highest performers likely would accumulate the most followers. Whereas in conventional social media the actual performance of any claimed leader is usually unknown, embodiments of the hybrid platform subject each aspiring leader to a transparent process that reveals the truth (about) in their claims, which may be quantified. It may be the case that certain users who considered themselves leaders are unable to maintain high performance, and conversely lesser-known members of the community may realize their inner potential.
Impact of Leadership on Community: Embodiments of the hybrid trading platform can directly observe the profitability of users who are following leaders and determine whether the actions taken by leaders result in measured benefits to people who follow them.
Community Self-Protection: If an established leader suddenly begins to perform poorly, due to any unintended or deliberate action, followers may see this happen and be presented with a decision on whether to continue to follow or unfollow that leader. In addition, some embodiments of the hybrid platform allow users to add “caveats” to the leaders who they follow. A user may elect to continue following a leader so long as the leader's profit over a certain period of time (or number of followers) remains above a specified threshold level. If the caveat is violated, an embodiment of the platform may automatically terminate the leader-follower relationships between that leader and one or more followers of that leader.
Ripple Effect: Through the use of some embodiments of the hybrid platform, the actions of one trader have the ability to influence the actions taken by a potentially large number of followers. As a result when a well-established leader who has many followers places a trade, the number of trades that enter the market would generating be amplified by a certain amount. An embodiment of the hybrid platform can estimate the magnitude of this “Ripple Effect” and can predict broader market impact of individual traders' actions. In various embodiments, the platform users may be compensated for providing their data to the hybrid platform. The value of user data and compensation in the form of a platform token are discussed below.

### Hybrid-Platform Token

Value of Platform Data: The user data collected by an embodiment of a platform can be a valuable resource, and that data is collected any time a user takes an action within the platform. Some embodiments of the hybrid platform focus on trading as the key point of collecting valuable data. When a user trades, he or she invests a portion of his or her own personal assets, effectively stating the user's belief that he or she has made a correct decision. The user may take many actions prior to placing the trade (fundamental analysis, technical analysis, discussion within the community), and as such the trade itself represents the value of the associated work involved in performing the trade, as realized by the trader. As is hereinafter described, the value of each trade can be proven (with confirmed authenticity of origination) and quantified (as a function of percentage profit realized and value of assets at risk) in units of a hybrid-platform token using embodiments of Proof of Trade algorithm.
The Hybrid Platform Digital Economy: The implicit value of the platform data can be harnessed to create a digital economy, and the currency of that economy can be the hybrid-platform token. The hybrid-platform token may be used as a reward to users for providing their personal trading data to the platform and, in the case of blockchain implementation, for donating their computer and network resources for maintaining integrity of the platform blockchain. In turn, some embodiments of the platform accept the hybrid-platform token as payment for a range of services (that are described above) that platform provides to its users.

After an embodiments of a hybrid platform is launched, the quantity of the hybrid-platform tokens in circulation may increase with the amount of user data that is collected. In addition, while the total quantity of the tokens to be produced can increase without a limit, the rate of token production per unit data may be decreased gradually over time. The drop-off in rate of production may be implemented as a mining reward that diminishes with the total token supply (e.g. an exponential decay). A gradually decreasing in token production rate per unit data generated can help incentivize more miners to support the platform blockchain early and reward users who supported the platform digital economy early-on, either by participating in the platform token sale or by actively contributing platform trading data to the blockchain.

There are multiple reasons why the value of the hybrid-platform token may appreciate over time. Besides the decreasing rate of token production with respect to rate of platform growth, the value of the hybrid platform token may grow as more features are added to the platform, through its early stages of development and into longer-term growth. In addition, capitalizing upon the growing user data set, an internal market for the machine learning based trading algorithms (aka trading bots) may be created as users pay for the right to access trading data collected by the embodiments of the hybrid platform and then sell the resultant algorithms back to the platform community for a fee determined by trading bot performance.

In addition to trading data and trading bots, the users themselves may be directly commoditized within the hybrid platform, e.g., via subscription and commission fees that are paid by followers who copy leaders' trades. Users can effectively invest in the performance of other users, and the success or failure of each user-investment may be tracked. A machine learning based trading bot can be constructed that invests in user portfolios. Besides broader market data, embodiments of the hybrid trading platform may provide access to social networking related data including follows/unfollows, likes/dislikes, and verbal conversations between by leaders and followers. This presents an opportunity to co-predict the interactions between individual users of the platform and the movements of entire digital financial markets.

It is likely that as the number of users and the amount of trading data grow that the best-performing individual traders and trading bots can reach higher levels of performance over time, further demonstrating appreciation of platform value per unit quantity of data generated by the platform. Given the network effects of users interacting with other users, algorithms operating on growing volumes of trades, cross-effects thereof (users on algorithms, algorithms on users) and multiple levels of recursion (users on algorithms on users, algorithms on users on algorithms, etc.) the rate of platform value creation can grow exponentially.

The presence of social media based community engagement tools directly in the trading platform can further catalyze the growth of the hybrid platform digital economy. Altogether, the many parallel avenues for value creation vs. few mechanisms of new token creation can ensure that the value of the platform token may continue to grow over time.

### The Proof of Trade Algorithm

The validation of user data collected by an embodiment of a hybrid platform and quantification of its value can be determined in some embodiments by a consensus algorithm called Proof of Trade. The Proof of Trade algorithm generally has four components:
1. Proof of Account Association. An account of a user of an embodiment of a hybrid platform that creates user trading data must be associated with an account that is held on a Asset Exchange.
2. Proof of Exchange Transaction. As a second minimal criterion, the platform user's trade that is claimed to have occurred must be provably linked to one or more transactions that occurs in a Asset Exchange, whether that exchange is centralized, distributed, or involving a cross-chain transaction/atomic swap. The reason for this proof is to ensure that all trades that are reported to an embodiment of a hybrid platform are authentic and contribute towards the dynamics of real asset markets.
3. Trade Volume Scaling. Larger trades are generally more valuable. When a user places more funds at risk in a specific trade, it suggests a higher level of confidence in that trade and hence more work involved in arriving upon the trading decision. The market value of the asset placed at risk itself can be a measure of work.
4. Trade Profit Scaling. More profitable trades are generally more valuable. This is an important component to Proof of Trade because a more profitable trade suggests that more work was invested by the user to arrive at the profitable decision. The profit scaling component of the Proof of Trade algorithm is realized when the trade is closed, i.e. when a certain quantity of asset has traversed a full cycle of exchange through two or more complementary financial operators (such as buy/sell, long/short, etc.) in one or more asset markets, resulting in an observed profit or loss.

The Proof of Trade algorithm computes the value of each trade that occurs within an embodiment of the hybrid platform, taking the above four components as input:

(Value of Trade)=(PoAA)*(PoET)*ƒ(TV,TP)

where
PoAA is 1 if the platform user account and an account on a Asset Exchange. PoAA is 0 otherwise.
PoET is 1 if the trade claimed by the hybrid-platform user account is provably linked to transactions that have occurred on a Asset Exchange and 0 otherwise
ƒ(TV, TP) is a relation taking as input trade volume in units of a specified base currency and trade profit as percentage increase or decrease in value of the trade.
(Value of Trade) is specified in units of the same base currency

Hence, according to the Proof of Trade algorithm each trade has value only when it is linked to a known platform user and a asset market, and that value is determined by the volume and profit of the trade.

### Human and Machine Agents

Every user of an embodiment of a hybrid platform can create value via the Proof of Trade algorithm. Importantly, for the purpose of value creation it does not matter whether the hybrid-platform user is a human or a machine agent (e.g. an agent generated by a machine learning algorithm). Because the Proof of Trade algorithm proves the link between a hybrid-platform user account, a asset market, and a quantified amount of risk and resultant profit, the value associated with market impact may be attributed the hybrid-platform user account, independently from the means or tools that the user employed to generate that impact. This opens the possibility for hybrid-platform users to market not only their own trading expertise but also the use of trading bots that are engineered to maximize profit and linked to hybrid-platform user accounts.

Given the possibility of both human and machine agents to interface with an embodiment of the hybrid-platform and post trades, certain users may wish to only follow user accounts that are provably linked to humans. This can be accomplished by any one of many user interaction models. For example, in some embodiments specific patterns of screen clicks, scrolls, mouse movements, and pauses between actions are analyzed on a desktop. Specific touch patterns, taps, and swipes, as well as gross movements of a hand-held device (e.g., a tablet, a smart phone, etc.) using the accelerometer, gyroscope and magnetometer may be examined on mobile devices. In addition, any platform or operating system specific metadata that is available may be used to strengthen the algorithm. As a possible starting point an embodiment of the hybrid-platform may integrate algorithms that are used in conventional Captcha code, which verify user interaction.

### Centralized Proof of Trade

An embodiment of the hybrid-platform uses the centralized server approach. The proof trading algorithm is implemented using a back-end server architecture that is secure and shielded from unauthorized outside access. In some embodiments, the implementation includes:
1. Proof of Account Association. The user logs in to the back-end server using a username and password combination stored on the server to retrieve credentials necessary to access the hybrid-platform user's account on a Asset Exchange.
2. Proof of Exchange Transaction. In the centralized implementation, an embodiment of the hybrid platform communicates directly from its back-end server to the exchange accounts held by users. Given that this communication originates from a closed system controlled by the hybrid platform, proof of exchange transaction can be guaranteed so long as server integrity is maintained, i.e. the hybrid platform servers are “trusted” to ensure proof of exchange transaction.
3. Trade Volume Scaling. A relation pre-determined by the hybrid platform is used in some embodiments to compute the value of the trade as a function of trade volume and profit.
4. Trade Profit Scaling. As described above.

### Blockchain Proof of Trade

The proof trading algorithm is also important to the operation within a blockchain of various embodiments of the hybrid platform. The algorithm generally includes:
1. Proof of Account Association. The private API key credentials necessary to access a the hybrid-platform user's account in a Asset Exchange are generally encrypted and stored in the hybrid-platform blockchain. Every hybrid-platform user possesses a private key that in turn may be used to decrypt the stored API key so that it may be used to access the Asset Exchange. The same hybrid-platform user private key may be used to digitally sign user trading information that is stored in the hybrid-platform blockchain, verifiably linking specific actions (trades) taken in specific asset markets to specific users of an embodiment of the hybrid-platform.
2. Proof of exchange transaction. In the blockchain implementation, a trade that is performed on a Asset Exchange may not be initiated by a privately controlled or “trusted” server. Instead, exchange transactions may be performed by a combination of user computers and masternodes (masternodes may be used to increase the volume of transactions that can be supported by the network). To implement proof of exchange transaction in a trustless manner, each exchange transaction is independently verified by multiple network nodes up to a minimally acceptable number of confirmations. In this manner, each full client node (and especially each masternode) endpoint communicates not only on behalf of its own user's transactions but also for the purpose of validating other users' transactions in the network. For each transaction, multiple end-user machines may communicate with a single exchange to ensure that every machine reports the same result. As is typical of blockchain technologies, a decentralized trustless transaction generally takes longer to complete than a centralized trusted transaction, due to multiple confirmations required to maintain integrity of data in the blockchain. This can in part be addressed by sharding the blockchain network into side-chains that facilitate rapid execution of a subset of all transactions that are occurring. Given leader/follower relationships that form by nature of various embodiments of the hybrid platform, these side-chains may be effectively organized to gather users who are more closely related in the social directed graph. In addition, as part of their platform client interface settings, a user may specify the number of transactions necessary to replicate a leader's order, enabling the user to effectively balance a compromise between transaction speed and risk/integrity of the data set.
3. Trade Volume Scaling. The same scaling algorithm may be used (as was used in the centralized implementation), subject to multi-node confirmation that the computed profit has indeed been realized according to the record of the trade in the exchange. 4. Trade Profit Scaling. As described above.

### Hybrid Platform Token Mining

When a hybrid-platform user performs a trade that is validated by the Proof of Trade algorithm, value is created within the hybrid platform. This value creation coincides with the generation of a certain quantity of hybrid-platform tokens, that may be used to compensate the individual or individuals who participated in the creation of value. When a trade is validated using the Proof of Trade algorithm, a hybrid-platform token may be created and awarded to the hybrid-platform user account that was identified by Proof of Account Association and any other hybrid-platform user accounts that participated in Proof of Exchange Transaction.

The hybrid-platform users may opt-in to allow their trading data to be collected and used for a variety of purposes, including:
1. To share with the broader social trading community
2. To be analyzed and “mined” for the purpose of constructing trading “bots”
3. To be analyzed by a third party external to the hybrid-platform for a specific purpose known to the hybrid-platform, which is clearly disclosed to and accepted by the platform users in advance.

In general, when users allow their personal trading data to be used for such purposes, they may be compensated by receiving hybrid-platform tokens in their wallets. The amount of compensation paid to the user may be scaled according to the amount of work that the user has performed, in accordance with the hybrid-platform Proof of Trade algorithm. In this manner, hybrid-platform may pay higher token reward fees to users who create more valuable data.

In addition, some embodiments of the hybrid-platform reward full nodes and mining nodes for performing network confirmations that are necessary to verify trades that have occurred on exchanges. A hybrid-platform full node is a computer connected (e.g., via the Internet) to at least one Asset Exchange and is capable both of accessing a hybrid-platform user account (using a private key) and of confirming the transactions of other hybrid-platform users on a Asset Exchange. A hybrid-platform mining node by comparison has similar blockchain access as compared to a full node, optionally with less user interface features to control a hybrid-platform user account and, optionally, more specialized hardware to maximize the rate of transaction confirmation.

When a hybrid-platform trade is confirmed, the hybrid-platform user account associated with the node that performed the confirmation may be rewarded by receiving a certain quantity of hybrid-platform tokens. As subsequent confirmations are performed for a specific hybrid-platform trade, subsequent rewards may diminish, as the initial confirmations are typically the most important. A specific relation may be used to determine the amount of hybrid-platform tokens that may be paid as a reward for each confirmation, taking as input the number of prior confirmations that have been performed, the time taken to perform the confirmation, the total hybrid-platform token supply, etc.

Given that each trade quantifies actual work performed by a trader in creating the trade, the hybrid platform can use this work to guarantee the integrity of its entire trading data set, provided that an appropriate algorithm is used to authenticate point of origin, maintain integrity in transit, and accurately quantify implicit value of the trade. Because of this implicit value, some embodiments of the hybrid platform reward users for producing trading data and confirming valid transfer of that data to the hybrid platform. Conversely, were the data to have no implicit value, the hybrid platform would have no direct incentive to pay users for generating it, and the users in turn would have no direct incentive to provide the data to the hybrid platform or confirm other users' transactions.

In the case of a centralized system architecture, this real, implicit value is immediately transferred to the hybrid platform upon completion of a transaction in the back-end server. However, in the case of a blockchain based architecture, the existence and preservation of implicit value in the trading data can promotes the proliferation of the hybrid platform's blockchain a distributed and trustless network architecture, incentivized by appropriately scaled rewards assigned to user endpoints and masternodes.

It is clear that there are many ways to configure the device and/or system components, interfaces, communication links, and methods described herein. The disclosed methods, devices, and systems can be deployed on convenient processor platforms, including network servers, personal and portable computers, and/or other processing platforms. Other platforms can be contemplated as processing capabilities improve, including personal digital assistants, computerized watches, cellular phones and/or other portable devices. The disclosed methods and systems can be integrated with known network management systems and methods. The disclosed methods and systems can operate as an SNMP agent, and can be configured with the IP address of a remote machine running a conformant management platform. Therefore, the scope of the disclosed methods and systems are not limited by the examples given herein, but can include the full scope of the claims and their legal equivalents.

The methods, devices, and systems described herein are not limited to a particular hardware or software configuration, and may find applicability in many computing or processing environments. The methods, devices, and systems can be implemented in hardware or software, or a combination of hardware and software. The methods, devices, and systems can be implemented in one or more computer programs, where a computer program can be understood to include one or more processor executable instructions. The computer program(s) can execute on one or more programmable processing elements or machines, and can be stored on one or more storage medium readable by the processor (including volatile and non-volatile memory and/or storage elements), one or more input devices, and/or one or more output devices. The processing elements/machines thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processing element as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted. Sets and subsets, in general, include one or more members.

As provided herein, the processor(s) and/or processing elements can thus be embedded in one or more devices that can be operated independently or together in a networked environment, where the network can include, for example, a Local Area Network (LAN), wide area network (WAN), and/or can include an intranet and/or the Internet and/or another network. The network(s) can be wired or wireless or a combination thereof and can use one or more communication protocols to facilitate communication between the different processors/processing elements. The processors can be configured for distributed processing and can utilize, in some embodiments, a client-server model as needed. Accordingly, the methods, devices, and systems can utilize multiple processors and/or processor devices, and the processor/processing element instructions can be divided amongst such single or multiple processor/devices/processing elements.

The device(s) or computer systems that integrate with the processor(s)/processing element(s) can include, for example, a personal computer(s), workstation (e.g., Dell, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a processor”, or “a processing element,” “the processor,” and “the processing element” can be understood to include one or more microprocessors that can communicate in a stand-alone and/or a distributed environment(s), and can thus can be configured to communicate via wired or wireless communication with other processors, where such one or more processor can be configured to operate on one or more processor/processing elements-controlled devices that can be similar or different devices. Use of such “microprocessor,” “processor,” or “processing element” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communication protocols, and unless otherwise specified, can be arranged to include a combination of external and internal memory devices, where such memory can be contiguous and/or partitioned based on the application. For example, the memory can be a flash drive, a computer disc, CD/DVD, distributed memory, etc. References to structures include links, queues, graphs, trees, and such structures are provided for illustration and not limitation. References herein to instructions or executable instructions, in accordance with the above, can be understood to include programmable hardware.

Although the methods and systems have been described relative to specific embodiments thereof, they are not so limited. As such, many modifications and variations may become apparent in light of the above teachings. Many additional changes in the details, materials, and arrangement of parts, herein described and illustrated, can be made by those skilled in the art. Accordingly, it will be understood that the methods, devices, and systems provided herein are not to be limited to the embodiments disclosed herein, can include practices otherwise than specifically described, and are to be interpreted as broadly as allowed under the law.

1. A method for facilitating community-based electronic trading on a hybrid social and trading platform, the method comprising the steps of:
establishing, for each platform user, one or more links between a platform account and one or more exchange accounts of that platform user;
for a first asset, designating one or more platform users as leaders and, for each leader, designating one or more platform users as direct followers of that leader;
generating by a processor, for integrity checking, a directed graph, generation of the graph comprising:
allocating in memory a node structure for each platform user; and
for each leader, providing one or more directed links from the node structure of that leader to respective one or more node structures corresponding to one or more direct followers of that leader; and
testing integrity by the processor by either detecting or confirming absence of a cycle in the directed graph.

2. The method of claim 1, further comprising performing by the processor the steps of:
detecting an action performed by a first leader with respect to the first asset;
recursively traversing the directed graph identifying one or more followers of the first leader, the one or more followers comprising at least each direct follower of the first leader;
generating a respective action copy for each of the identified one or more followers;
selecting a set of eligible followers from the identified one or more followers according to the respective action copy;
selecting a subset of eligible followers from the set of eligible followers; and
executing, for each eligible follower from the subset of eligible followers, the respective action copy by transmitting a respective trading order to a respective exchange using a link between the platform account of that eligible follower and an exchange account of that eligible follower.

3. The method of claim 2, wherein selecting the subset of eligible followers comprises selecting each eligible follower from the set of eligible followers that has a respective user property auto-execute.

4. (canceled)

5. The method of claim 2, wherein selecting the subset of eligible followers comprises:
for each eligible follower from the set of eligible followers that has a respective user property confirm-execute, displaying, in a display panel of that follower: (i) the respective action copy and (ii) a respective user interface (UI) for confirming or rejecting the respective action copy;
receiving from each of one or more eligible followers, via the respective UI, a respective confirmation signal; and
including in the subset of eligible followers the one or more eligible followers that provided the respective confirmation signals.

6. (canceled)

7. The method of claim 2, further comprising:
prior to the executing step, ordering by the processor, the subset according to: a time at which a leader-follower relationship was established between the first leader and a particular eligible follower; a degree by which a particular eligible follower is separated from the first leader in the directed graph; a frequency at which a particular follower followed other actions of the leader; a time at which a particular follower last followed another action of the leader; a premium associated with a leader-follower relationship between the first leader and a particular follower; or a randomized order,
wherein during the executing step each eligible follower is selected in order from the ordered subset.

8. The method of claim 2, wherein a trading metric or a social metric is associated with the first leader, the method further comprising:
displaying in display panels of each one of the one or more followers of the first leader the trading metric or the social metric.

9. (canceled)

10. (canceled)

11. (canceled)

12. The method of claim 2, wherein for each eligible follower from the subset of eligible followers transmitting the respective trading order comprises signing the respective trading order using a respective private key of that eligible follower.

13. (canceled)

14. The method of claim 2, wherein:
generating an action copy for each identified follower comprises replicating the action of the first leader for a respective follower-trade amount that is a function of: (i) a percentage of a leader-trade amount of the action of the first leader within a portfolio of the first leader, and (ii) a proportion of a portfolio of that identified follower that is designated to follow the portfolio of a direct leader of which the identified follower is a direct follower; and
selecting the set of eligible followers from the identified one or more followers according to the respective action copy comprises selecting one or more followers from the identified one or more followers having the respective follower-trade amount available.

15. (canceled)

16. The method of claim 2, wherein:
generating an action copy for each identified follower comprises replicating the action of the first leader for a respective follower-trade amount that is a function of: (i) a rank of the first leader, (ii) ranks of all leaders the respective follower directly follows, or (iii) ranks of all designated leaders for the asset of interest, a rank of each leader being based on a trading metric or a social metric for that leader.

17. The method of claim 2, wherein:
testing integrity comprises detecting a cycle in the directed graph; and
recursively traversing the directed graph comprises:
identifying a pair of platform users having a leader-follower relationship that caused the cycle;
tagging a follower in the pair; and
terminating the recursive traversing when a visit to the tagged follower is repeated.

18. The method of claim 1, wherein a particular user is designated as both leader and follower.

19. The method of claim 1, wherein testing integrity comprises detecting a cycle in the directed graph, the method further comprising:
identifying a pair of platform users having a leader-follower relationship that caused the cycle;
terminating the leader-follower relationship between the platform users of the pair; and
displaying an alert message in respective display panels of the platform users of the pair, informing the termination of the relationship.

20. A method for facilitating community-based electronic trading on a hybrid social and trading platform, the method comprising the steps of:
providing a respective first user interface (UI) on respective display panels of one or more platform users, enabling the one or more platform users to initiate a discussion in association with a trade in an asset;
upon initiation of the discussion by a first user, displaying on the display panel of the first user a second UI for entering an initial comment, the initial comment comprising a text message, an image, or an emoji; and
displaying a respective third UI on respective display panels of a set of platform users, enabling the platform users in the set to post a subsequent comment in response to the initial comment, the subsequent comment comprising a text message, an image, or an emoji, or a like or dislike signal, the third UI comprising the initial comment,
wherein the set of platform users comprises platform users associated with the asset or the first user.

21. The method of claim 20, wherein:
the trade comprises a trade executed by the first user or a trade proposed by the first user; and
the respective third UI comprises a profitability ranking for the asset of the first user or a number of followers of the first user.

22. The method of claim 20, wherein upon posting of a subsequent comment by a second platform user, updating for each platform user in the set of platform users the respective third UI with the subsequent comment.

23. The method of claim 22, wherein updating the respective third UI comprises displaying therein a profitability ranking for the asset of the second user or a number of followers of the second user.

24. The method of claim 20, wherein updating the respective third UI comprises displaying therein a count of subsequent comments, a count of likes, or a count of dislikes.

25. A method for displaying asset prices and order densities, the method comprising the steps of:
obtaining for an asset at each instance of time in a plurality of time instances during a specified time window, a respective cumulative order volume distribution over a price range;
generating for each instance of time in the plurality of time instances a respective order density distribution by computing a price derivative of the respective cumulative order volume distribution;
discretizing each order density distribution over a plurality of price points in the price range;
displaying for the asset a price chart on a time-price grid, each grid point corresponding to a respective pair of: (i) an instance of time in the specified time window and (ii) a price point in the price range; and
overlaying on the price chart discretized order density values, each discretized order density value corresponding to a respective grid pint, the overlaying step comprising setting an optical property of a pixel at the grid point according to the corresponding discretized order density value.

26. The method of claim 25, wherein the optical property comprises an intensity of the pixel, a saturation of the pixel, or a red-green-blue-alpha (RGBA) value of the pixel.

27. The method of claim 25, wherein:
the discretized order density values comprise a set of discretized buy order density values and a set of discretized sell order density values; and
the overlying step comprises setting pixels corresponding to discretized buy order density values to a first color and setting pixels corresponding to discretized sell order density values to a second color different from the first color.

28-54. (canceled)
